(19) United States
(12) Patent Application Publication
(10) Pub. No.: US 2002/0040389 A1
(43) Pub. Date: Apr. 4, 2002

(54) System and method for remotely-managed content distribution network

(75) Inventors: William F. Gerba, Coral Springs, FL (US); Jeremy Zaretzky, Coral Springs, FL (US)

Correspondence Address: GUNSTER, YOAKLEY & STEWART, PA, BROWARD FINANCIAL CENTRE, SUITE 1400, 500 EAST BROWARD BLVD, FT LAUDERDALE, FL, 33394, US

(73) Assignee: WireSpring Technologies, Inc.

(21) Appl. No.: 09/968,366

(22) Filed: Oct. 1, 2001

Related U.S. Application Data
(60) Provisional application No. 60/237,948, filed on Oct. 3, 2000.

(51) Int. Cl. G06F 15/173; G06F 15/16

(52) U.S. Cl. 709/219; 709/242

(57) ABSTRACT

A system and method for a remotely managed content distribution using a communication network. A central server stores instruction data in which the instruction data includes a name corresponding to content data. A node is in data communication with the central server via the communication network. The first node has a transceiver and a central processing unit. The transceiver receives the instruction data from the central server. The central processing unit constructs a network structure table corresponding to a network topology and locations of content within the network. The first node uses the network structure table to determine the location of content corresponding to the name of the content data in the received script.

### CROSS-REFERENCE TO RELATED APPLICATIONS

This Application is related to and claims priority to U.S. patent application Ser. No. 60/237,948, entitled SYSTEM AND METHODS FOR REMOTELY-MANAGED CONTENT DISTRIBUTION NETWORK, filed Oct. 3, 2000, the entire contents of which are incorporated herein by reference.

### STATEMENT REGARDING FEDERALLY SPONSORED RESEARCH

N/A

### FIELD OF THE INVENTION

The present invention relates to content distribution networks, and in particular to a system and method for remotely managing content distribution networks optionally having one or more wireless communication links. BACKGROUND OF THE INVENTION

Recent advances in networking technologies, more specifically the advent of e-commerce and the cultural acceptance of the Internet as a place of commerce, has left many traditional retailers looking for new ways to improve customer relations while also increasing their own bottom line. Retailers have identified advertising at the point-of-sale as a potentially viable method of reaching consumers at decision-making points in their shopping routines, possibly influencing their purchasing decisions. Many traditional retailers are also looking to implement new vivid content technologies in their places of commerce in an attempt to bring some of the conceived glamour and allure of on-line shopping into the traditional brick and mortar shopping world.

Advertising at the point-of-sale has traditionally been limited to static displays, including still images and poster boards, product labels and packaging, etc. Looking to revitalize sales and improve advertising penetration rates, many retailers have turned to vivid media solutions, namely advertising systems which allow for the display of multi-media content like full motion video, audio, animation and the like. In the past, such systems have ranged in complexity from simple television-VCR combinations running videotape loops, to enormously complicated and expensive closed-circuit in-store television networks who buy satellite systems from broadcasting centers.

While the former are subject to frequent mechanical failures, poor video quality, and distribution difficulties when new content needs to be added, the latter are often too expensive and complicated for all but the largest retail chains, and can be very costly and time-consuming to use and maintain. While the power of television-like advertising at the point-of-sale is questioned by few, most acknowledge that there is no convenient and inexpensive way to implement it in host locations.

Many variations of in-store television networks have been attempted Some of the newer and more successful variations have used a fast connection to the Internet via analog modem, digital subscriber line (DSL), cable, fiber optic connection or satellite, to receive advertising and programming content from a centralized server at a remote location. However, even with these technological advances, the systems have remained costly, cumbersome, unreliable and inefficient.

A significant cost is derived from system installation, which in many cases involves running hundreds of thousands of feet of data cable from local computers to display terminals. Additionally, obtaining a fast connection to the Internet may involve installing phone lines, cables, satellite dishes or other expensive equipment which adds to the cost and complexity of the overall system.

It is therefore desirable to have a system and method which provides a simple, inexpensive and reliable way to deliver and manage content such as audio, visual and other multimedia content remotely.

### SUMMARY OF THE INVENTION

The present invention advantageously provides a simple, low cost method and system which alleviates the problems found in known point-of-sale audio/visual advertising systems. According to one aspect of the present invention, client nodes at a remote host location, such as a retail store, perform a process which automatically initiates a session, i.e. logs on, to a central server via a high-speed connection, preferably a wireless high-speed connection, using a communication network such as the Internet, and downloads digital content and scheduling files predetermined by the operators of the system. Once the files are downloaded, the client nodes begin playing the content at the designated times and dates according to the information from the scheduling files. As used herein, “playing” refers to displaying visual content and audibly reproducing audio content. The avoidance of hard-wiring the client nodes to a network advantageously allows end-users and/or system operators to place client units at a variety of diverse locations and relocate them within the location, thereby giving end-users more control over in-store marketing and advertising strategies.

In accordance with an aspect of the present invention, a communication network-based content distribution system is provided in which a central server stores instruction data. The instruction data includes a name corresponding to content data. A first node is in data communication with the central server via the communication network. The first node includes a transceiver and a central processing unit. The transceiver receives the instruction data from the central server. The central processing unit constructs a network structure table corresponding to a network topology and locations of content within the network. The first node uses the network structure table to determine the location of content corresponding to the name of the content data in the received instruction data.

According to another aspect, the present invention provides a network-based content distribution method in which instruction data is received from a central server. A network structure table corresponding to a network topology and locations of content within the network is constructed. The network structure table is used to determine the location of content corresponding to a content data name in the received instruction data.

According to yet another aspect, the present invention provides a node in a network-based content distribution system in which the node has a transceiver operable to receive instruction data. The instruction data includes a name corresponding to content data. A central processing unit is in electrical communication with the transceiver and performs functions including constructing a network structure table corresponding to a network topology and locations of content within the network, determining the location of content corresponding to the content data name in the received instruction data, and using the transceiver to obtain the content corresponding to the content data name in the received instruction data. A playing device is in electrical communication with the central processing unit and is operable to play the obtained content data.

### BRIEF DESCRIPTION OF THE DRAWING FIGURES

A more complete understanding of the present invention, and the attendant advantages and features thereof, will be more readily understood by reference to the following detailed description when considered in conjunction with the accompanying drawings wherein:

FIG. 1 is a diagram of a content distribution system constructed in accordance with the principles of the present invention;

FIG. 2 is a block diagram of an exemplary arrangement of a client node constructed in accordance with the principles of the present invention;

FIG. 3 is a diagram showing a virtual network arrangement;

FIG. 4 is a diagram of multiple clients arranged in a single local area network structure;

FIG. 5 is a diagram of multiple clients arranged in two distinct isolated local networks;

FIG. 6 is a flow chart of a primary initialization procedure performed by each client;

FIG. 7 is a flow chart of an update and file download procedure for an initialized node;

FIG. 8 is a flow chart of a network initialization process;

FIGS. 9A, 9B, 9C and 9D are a flow chart of a collaborative ad-hoc networking initialization process;

FIGS. 10A and 10B are a flow chart of a collaborative downloading process; and

FIGS. 11A, 11B, 11C, 11D and 11E are a flow chart of a gateway node process.

### DETAILED DESCRIPTION OF THE INVENTION

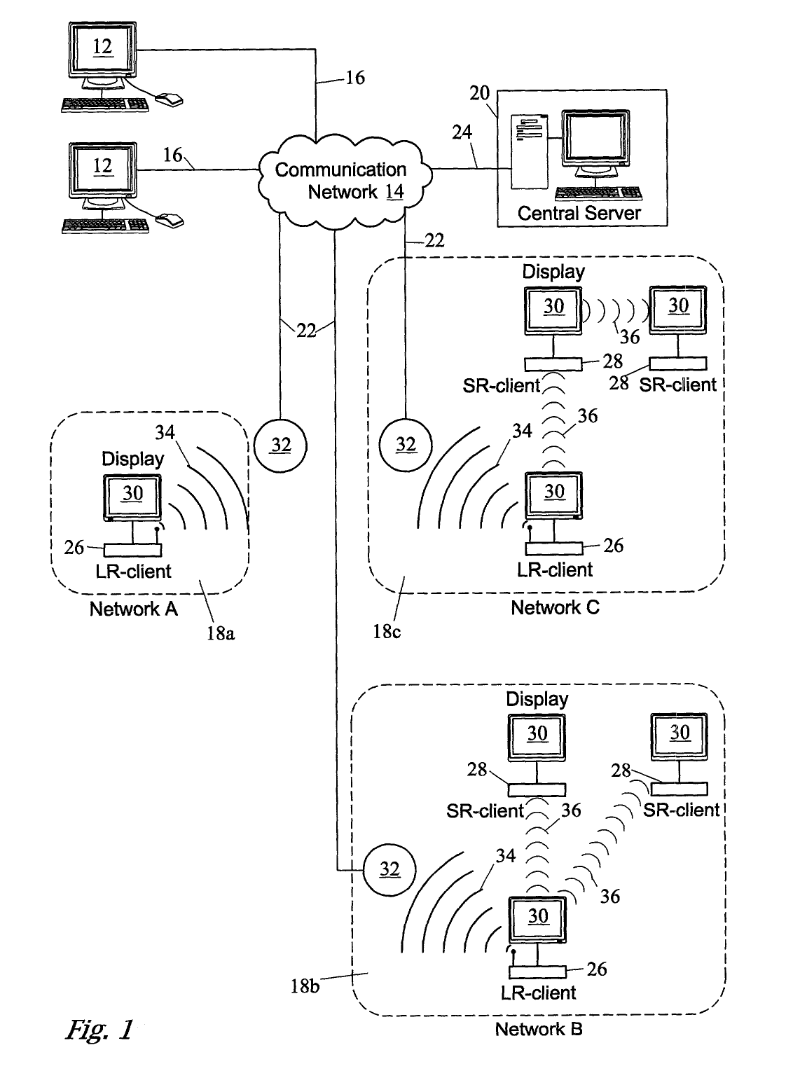

Turning now to the drawing figures in which like reference designators refer to like elements, there is shown in FIG. 1 a content distribution system constructed in accordance with the principles of the present invention and designated generally as “10”. Content distribution system 10 is comprised of one or more user devices 12 coupled to communication network 14 via user communication links 16. Also coupled to communication network 14 are one or more remote networks 18 (shown in FIG. 1 as networks 18a, 18b and 18c corresponding to Network A, Network B and Network C, respectively) and one or more central servers 20. Networks 18 are coupled to communication network 14 by one or more corresponding remote network links 22. Central servers 20 are coupled to communication network 14 by a corresponding server link 24.

Communication network 14 can be any network capable of transporting information between user devices 12, networks 18 and central server 20 such as the Internet but can also be any suitable public or private communication network. User communication link 16, remote network links 22 and server links 24 can be any suitable communication link technology such as a dedicated leased line, Digital Subscriber Line (DSL), Integrated Services Digital Network (ISDN), Asynchronous Transfer Mode (ATM) link and can take the form of any combination of wireless communication links such as microwave, satellite and the like or hard-wired connections. Similarly, the data transport rate of these links is established based on traffic and throughput needs, as can be designed and determined by one of ordinary skill in the art. Communication protocols can take the form of any suitable protocol such as the Transmission Control Protocol/Internet Protocol (TCP/IP).

Central server 20 is a computing device which can take the form of a mini computer, microcomputer or mainframe computer operable to perform the functions described herein. Central server 20 is preferably configured with a permanent storage device, such as a hard drive adapted to store content data, programmatic software code and the like and is capable of executing an operating system such as UNIX, LINUX or Windows NT. Further, it is anticipated that central server 20 includes the hardware and/or software necessary to couple central server 20 to server link 24 for communication with the other components of content distribution system 10 It is expected that the individual capacities and capabilities of the components of central server 20 are designed based on expected loads as may be determined by one of ordinary skill in the art.

Each network 18 includes a Long Range-client (hereinafter “LR-client”) 26 and may optionally include one or more Short Range-clients (hereinafter “SRclient”) 28, each of which has a corresponding display device 30 such as a monitor, television, etc. and/or an audio playback device (not shown). It should be noted that the general use of the term “client” herein refers to both LR-clients 26 and SR-clients 28.

LR-clients 26 send and receive data to and from communication network 14 via a corresponding wireless access point 32. Of course, LF-clients can also communication via a hard-wired connection. As such, and as described below in detail, LR-clients 26 are equipped with long-range communication peripherals such as wireless transceivers or ethernet adapters. Wireless access points 32 are adapted to receive and transmit data to and from LR-clients 26 via a corresponding remote network link 22. Further, LR-clients 26 are optionally configured with short-range wireless transceivers to communicate with SR-clients 28 within their network. The short-range wireless connection scheme implemented preferably provides data throughput rates greater than or equal to the technology used by LR-clients 26. Although the present invention is described in terms of wireless communication between SR-clients 28 and LR-clients 26, and LR-clients 26 and wireless access points 32, it is contemplated that any or all of these wireless communication arrangements can be implemented using hard-wired connections. For example, although Network A 18a is shown in FIG. 1 as using wireless access points 32, it is contemplated that LR-client 26 can communicate with other network devices via a hard-wired connection to its corresponding remote network link 22.

Preferably, although not required, long-range (“LR”) wireless links 34 provide for communication with wireless access point 32 and communication network 14 with a bandwidth equal to or greater than 128 kilobits per second. The long-range wireless transceivers (described below) are preferably able to connect to a service provider's wireless point 32, such as an Internet wireless access point, several hundred to several thousand meters away using the TCP/IP protocol. SR-clients 28 communicate between themselves and/or LR-clients 26 via short-range (“SR”) wireless links 36. SR wireless links 36 can be any suitable short-range (i.e. less than several hundred meters) transmission technology which preferably utilizes TCP/IP, is capable of operating at speeds equal to or greater than 10 megabits per second and is compatible with a known standard such as American National Standards Institute (ANSI) standard 802.1 lb, also referred to as wireless Ethernet.

System 10 also preferably uses a secure file transmission method such as secure File Transmission Protocol (FTP) to establish connections with central server 20. Central server link 24 is preferably a link having a data throughput capability of at least 1.5 megabits per second. LR-clients 26 and SR-clients 28 can implement any suitable operating system capable of performing the functions described herein. For example, it has been found that client units can be fitted to run a version of the LINUX Operating System which has been modified to support wireless communication. It is contemplated that one of ordinary skill in the art could modify the LINUX Operating System to provide such wireless communication support.

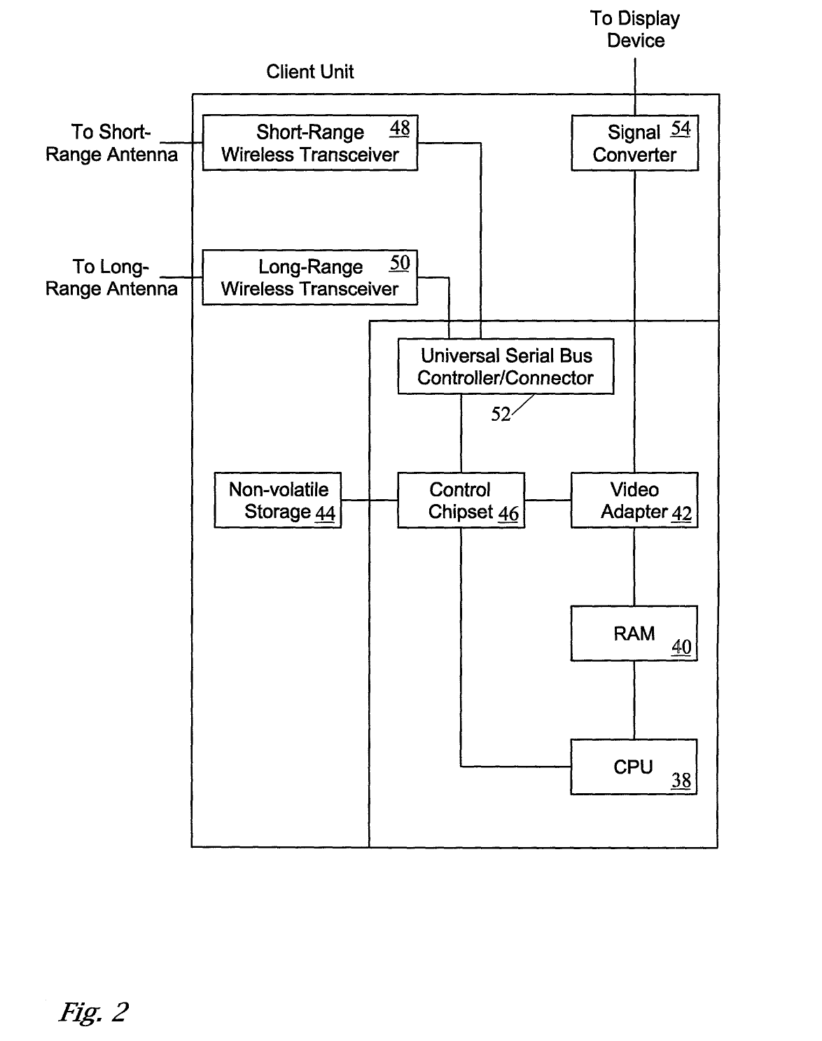

An exemplary arrangement of a client node such as an LR-client 26 or SR-client 28 is described with reference to FIG. 2. As shown in FIG. 2, a client unit preferably includes a central processing unit (“CPU”) 38 capable of running an operating system, a random access memory (“RAM”) 40, a video adapter 42 adapted to output a video signal such as a VGA signal and non-volatile storage 44 such as a hard disk drive, and a control chip set 46 arranged to allow video adapter 42, RAM 40, CPU 38 and non-volatile storage 44 to communicate with each other via electrical connections. Of course, it is contemplated that there are many suitable ways to interconnect the above-described components.

As shown in FIG. 2, a client node also optionally includes one or more short-range wireless transceivers 48 and long-range wireless transceivers 50 which communicate with the other client node components through a controller/connector 52 such as a universal serial bus (USB) controller/connector. It should be noted that LR-clients 26 are equipped with long-range wireless transceiver 50 and optionally one or more short-range wireless transceivers 48. SR-clients 28 do not include long-range wireless transceiver 50. Short-range wireless transceivers 48 and long-range wireless transceivers 50 are electrically coupled to corresponding antennae (not shown). The clients may be directly connected to a VGA-capable display device via video adapter 42 or capable of connection to a standard television via signal converter 54 electrically coupled to video adapter 42.

Referring again to FIG. 1, various quantities of client units can be installed in multiple separate physical installation sites such as Network A 18a, Network B 18b, and Network C 18c. For example, as shown in FIG. 1, Network A 18a includes only a single LR-client 26, while Network B 18b includes a single LR-client 26 wirelessly communicating with two SR-clients 28. Network C 18c includes an LR-client 26 and two SR-clients 28. However, in the case of Network C 18c, LR-client 26 communicates indirectly with one of the SR-clients 28 via the other of the SR-clients 28.

Although a detailed description of the operation of the present invention is described below, a more general description is provided with reference to FIG. 1 to aid the reader's general understanding of the present invention.

Regarding network topology and structure, clients run an operating system such as those described above which allows for ad-hoc networking (preferably wireless networking), over both short-range and long-range devices. Every client also executes a common network protocol, such as TCP/IP, which allows for inter-client communication. When a client is started and the network is initialized, every client device searches for other client devices within its local network. As used herein, local is defined as the effective broadcasting radius of a client's short-range wireless transceiver 48 or the local area network (LAN) in the case where SR-client 28 is hardwired to the local network. At periodic intervals, each client sends out packets of information in an attempt to discover whether any new clients have been added to the local network, and similarly listens for incoming packets from other clients attempting to establish a connection. Upon receiving a signal from another client in the local network, the first client establishes a connection with the second, and transmits a hierarchically arranged list of all other clients known to be networked in the local network. In turn, the second client transmits its list if it has such a list. Each client integrates the list into its local area network map, thereby storing the names and network addresses of all known clients on the network.

As this list spreads from one client to the next, a map of the network topology at the installation local network is formed, which each client eventually comes into possession of as the list gets passed from one client to the next via network communications. Further, because all clients seek to update this information throughout the day, it can be insured that every client has an accurate map of the entire local network. A list of each client's status (active or inactive) is passed along in the aforementioned inter-client communications as well as an indicator establishing the type of client (short-range and/or long-range). The hierarchical lists are used by the client devices as a “map”, thereby giving each device a path as to how to reach every other locally-available client.

Knowledge of which clients are SR-clients and which are LR-clients is useful because the LR-clients are the clients capable of connecting to central server 20 to search for and download content and scheduling updates. Thus, LR-clients 26 may serve as gateway nodes, thereby allowing other clients connected through the local network such as Network A 18a, Network B 18b, and Network C 18c to connect via communication network 14 to central server 20. This arrangement advantageously allows all devices to have access to data initially stored on central server 20 without being physically equipped with long-range wireless connection technologies. Therefore, because each local network 18 contains at least one LR-client 26 and the LR-client 26 can reach all other clients via some network path, every client in the network can obtain its data from the central server 20 or some other node which has desired content data.

At predetermined times throughout the day, each client remotely connects to central server 20 via communication network 14 to check for new and/or revised content data and schedule files. Each client has a unique User Identification Number (“UIN”) which is sent to central server 20. Central server 20 uses the UIN to direct each client to a specific location in its file system where content and scheduling updates for that particular client are located. LR-clients 26 or other gateway nodes can simply connect directly to central server 20 through communication network 14 using long-range wireless transceiver 50 or other network technology. SR-client 28 locates an LR-client 26 in order to retrieve data directly or indirectly from central server 20. SR-client 28 connects to LR-client 26 directly (if the LR-client 26 is within its short-range broadcasting radius) or by “hopping” across other SR-clients 28 using the collected network topology map data to select a route which will allow SR-client 28 to reach an available LR-client 26.

An SR-client 28 needing to connect to central server 20 attempts to contact all LR-clients 26 in its local network 18a, 1 8b, 18c to determine which LR-client 26 is most capable of handling the connection request. Upon finding an LR-client 26 capable of acting as a gateway to central server 20, SR-client 28 sends a request to use the bandwidth resources corresponding to LR-client 26 or to download a file from LR-client 26. LR-client 26, in turn, adds this request to a queue. If LR-client 26 is capable of acting as a gateway, it answers the request from SR-client 28 with data representing how much bandwidth is available, whether the requested file is available, which other (if any) SR-clients 28 already have requested the file or have the requested file, and how many (if any) requests were in queue before the current request was made. Because SR-client 28 will have knowledge of all of the LR-clients 26 in its local network according to the network topology information that SR-client 26 gathered during the course of its operation, SR-clients 28 will be able to judge which LR-client 26 is able to most quickly and efficiently handle a connection request.

After determining which LR-client 26 will handle the request, SR-unit 28 preferably sends a cancel instruction to any of the other LR-clients 26 reporting longer potential delays and less available bandwidth. For the remainder of the communication session, SR-client 28 will use the bandwidth resources of the selected LR-client 26. Additional requests by SR-client 28 would begin a new query process, insuring that every request by every SR-client 28 is fulfilled with optimal efficiency. This arrangement also advantageously helps to balance the request queues for all LR-clients 26 in local network 18a, 18b and 18c.

LR-units 26 connect to central server 20 through communication network 14. As discussed above, each client connects to central server 20 several times a day to check for new or revised data and also to report its client status (e.g. functional, requires maintenance, etc.). A client which does not connect to central server 20 for a predetermined amount of time is considered to be malfunctioning by central server 20, thereby preferably initiating a process which notifies a qualified technician. Upon connecting to central server 20, each client uses its UIN to access its file area within central server 20. Upon accessing this file area, the client attempts to download information including which content data need to be downloaded, how the contents should be displayed, i.e. schedules, which software updates must be downloaded and run and which programs need to be executed locally by the client.

Each client downloads this information and processes it locally, forming a queue of tasks which need to be completed. Local tasks which require the client's CPU 38 but do not require the downloading of additional data are scheduled to run when CPU 38 has sufficient available resources. Tasks in the queue which do not require that additional files be downloaded are distributed to local SR-clients 26 and also other local SR-clients 28. Because the data throughput rate of short-range wireless links 36 are preferably greater than or equal to the data transmission rate achievable using long-range wireless links 34, it is advantageous for each client to check its own local network to see if a file is available through a short-range link prior to attempting to download the file from central server 20 through an LR-client 26. The files which are located on the local network (18a, 18b or 18c) are downloaded directly through short-range wireless link 36.

Files not found on the corresponding local network are requested from central server 20 through the local LR-clients 26 acting as gateways. File transfer is preferably handled using well known protocol such as FTP and/or UNIX to UNIX Copy Protocol (UUCP).

The hardware arrangement of the present invention advantageously solves many of the problems associated with bringing multimedia content to retail venues and the point-of-sale by using wireless technologies to make installation, use and maintenance of the content distribution networks as simple, straight-forward, reliable and flexible as possible. It should be noted that, although FIGS. 1 and 3-5 show LR-client 26 as the gateway, it is contemplated that other arrangements are possible. For example, a wireless router can be hard-wired to communication network 14 in which the wireless router supports wireless communications between one or more SR-clients 28. In this case, one of the SR-clients 28 or a separate device in data communication with the wireless router is used to perform the gateway functions described above and described below in detail. As such, all references to LR-client 26 performing a gateway function are understood to also be implementable on a separate gateway device or a SR-client 28 equipped with gateway functionality.

To prevent data corruption and imperfect file transfers across system 10, a file verification system is preferably used. It is contemplated that system 10 will employ file integrity verification calculations (known as checksums) at several points in the download and maintenance processes to insure file integrity. All checksums are preferably described as self-verifiable pseudo 64-bit strings. The physical representation of the checksum could be a string of 6 hexadecimal pairs, for example:

3A 5F 66 3A 5F 66

This checksum is described as pseudo 64-bit because the string has only 32 significant bits, which are then doubled. Note that the first three digit pairs in the string above are duplicated in the second three pairs. This is done to insure that the checksum itself is valid (through a process known as parity checking). Thus, the checksum itself is only 32 bits wide. A 32-bit combination allows for over four billion possible permutations. The first check a client performs with the checksum is the parity check to verify that the first three hexadecimal pairs and the second three hexadecimal pairs match. If they do not, it indicates that the checksum is invalid, and cannot be used to verify other files. Once the checksum is self-verified, it can be used to verify another file. The three significant hexadecimal pairs themselves are calculated with algorithms involving digital file's size, the contents of the file itself, and a number of computational calculations.

The algorithms are designed to insure that the checksum pairs are unique, making it highly unlikely that any two files could produce the same checksum, or that a computer checksum might be equal to some randomly generated hexadecimal sequence. The algorithms, which are known by all clients, can thus be computed on downloaded files. The results of these computations produces either a hexadecimal string identical to the checksum (demonstrating that the file is valid), or one different from the checksum demonstrating that it is invalid. Invalid downloaded files are then redownloaded by the client until whole-file integrity is achieved. Of course, other file integrity verifications can be used. Generating the checksum can be implemented, for example, by modifying the Luhn checksum generation formula to produce results in base 16 (as opposed to base 10). It is presumed that one of ordinary skill in the art can adapt the Luhn formula to provide a base 16 result. The modified Luhn generation formula yields a hexadecimal result, thereby providing three hexidecimal pairs. Duplicating the three pairs provides the above-described 64-bit string. Of course, other methods for generating a three hexidecimal pair checksum can be used. The present invention is not limited to a three hexidecimal pair checksum. It is contemplated that any suitable checksum generation method can be used.

Among the data to be downloaded by a client from central server 20 is its master script. The master script includes instructions specific to each client, including a list of which new or revised content data should be downloaded, which content script files to download, what commands, software patches and upgrades to run, if any. Both the master script and any additional content scripts generated by central server 20 are at least partially based on instructional input from end-users via user device 12 and/or other support staff. Although the present invention is described using script files, it is contemplated that instruction data is not limited to such. In addition to script files, instruction data can be comprised of multiple files and/or a data stream such as may originate from a database.

Master instruction data, such as the master script, may include but is not limited to one or more of the following: the UIN corresponding to the client, a checksum for the master script itself, a list of new or revised content data to obtain such as by download or a data stream, a list of new content script files to download, checksums for each of these files, specific commands and actions to be executed, and time/date limitations to insure that the files are downloaded and the commands executed within a specific time frame. Content instruction data, such as content script files, may include but are not limited to one or more of the following: a checksum for the script file itself, a list of content data to play, instructions (including loop, repeat and other directives) for playing the content data in specific sequences and at specific times, commands sequences to execute at specific times/dates, and commands to log events and maintain the client.

As shown in FIG. 1, user device 12 is used by end-users to configure system 10. Through user device 12, end-users are able to control which data is displayed on which clients by using a program such as a secure worldwide web-based program to access central server 20. The program allows end-users to create and modify schedule files as well as upload, download and delete content data. Content data can be any suitable data such as video content data, audio/visual content data, etc. which is adapted to be downloaded by a client as one or more complete files or sent to the client as streaming data. Changes to content configurations can be applied to single clients, groups of clients or all clients maintained by the end-user. Clients can be arranged into hierarchical groups according to the user's needs, and changes can be applied within groups, specific subgroups or across multiple groups. By implementing the program on user device 12 as a web-based program, this arrangement provides a convenient front-end to a database controlled by central server 20. Each change an end-user makes during the session is logged by a database, and updates one or more of the script files described above.

The end-user interface preferably provides an authentication method which, once authentication is successful, starts a communication session which allows a user to manage clients, manage content and/or manage scripts. Client management may include one or more of viewing client status, viewing client settings such as network settings and content settings, and modifying groups to create new groups of clients, delete groups of clients, add clients to a group or delete clients from a group. Content management preferably includes one or more of modifying resident content data to add a file, delete a file and/or rename a file, preview content, schedule content download to particular clients and/or groups. Managing scripts includes one or more of creating new script, editing existing script, deleting scripts from clients and/or groups, or applying scripts to client and/or groups. It is contemplated that one of ordinary skill in the art can write programmatic code using a conventional programming language such as C++, Visual Basic, object oriented and/or structured query language databases, and the like to implement the above-described management functions.

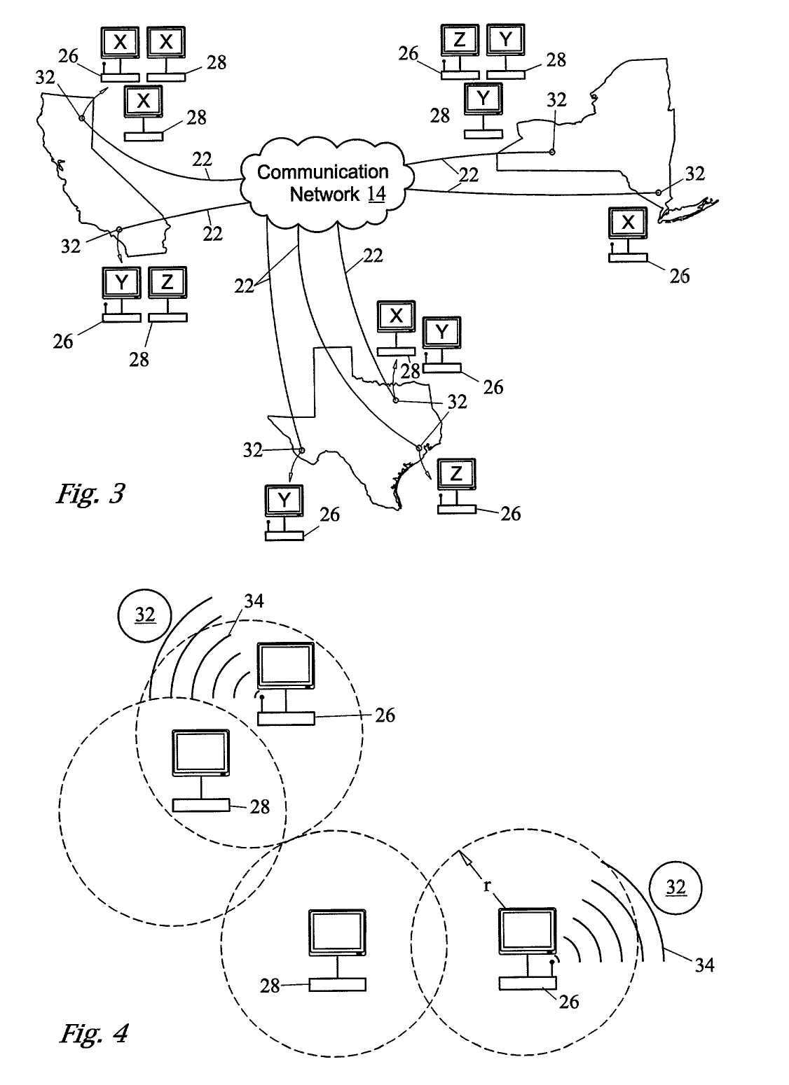

Although the arrangement of components in FIG. 1 shows three separate local networks, each of these networks can be subdivided to play more than one or different content loops. In other words, virtual networks can be created which span multiple local networks. An example of this virtual network arrangement is described with reference to FIG. 3 in which central server 20 and user devices 12 are omitted for the sake of clarity. FIG. 3 shows maps of California, Texas and New York, each having wireless access points 32 for facilitating communication with network communication network 14 via remote network links 22. Multiple systems can be deployed over a very wide area and still be synchronized with each other.

As shown in FIG. 3, three separate content loops are provided, namely content loop X, content loop Y and content loop Z. Each of content loops X, Y and Z can be played on one, another or both of LR-clients 26 and SR-clients 28. These content loops can be homogenous within a local network such as the clients corresponding to the northernmost access point 32 in California, or can be heterogeneous and show different content on client units such as content loops Y and Z shown connected to the westernmost access point 32 in New York.

As such, the present invention is quite advantageous for those users who need to disseminate content to receivers in geographically diverse areas, even where the disseminated video content is the same for certain areas and different for others. Further, this arrangement allows a network provider to carve up a physical network into the above-referenced virtual networks. Using a communication network 14, such as the Internet, combined with wireless technology to disseminate the data stored on central server 20 allows users to maintain and synchronize presentations in client units in networks across the world. An establishment wishing to send different marketing content or advertisements, for example, two different geographic regions, would easily be able to accomplish the task using the present invention. Because each client unit is individually addressable, it can be controlled remotely via user device 12 directly or via central server 20.

Each installation of clients may include one or more local networks. For example, FIG. 4 shows an installation of multiple clients arranged in a single local area network structure. As shown in FIG. 4, each client has a short-range wireless communication range defined by radial distance “r”. As such, wireless communication connectivity is available all the way from one LR-client 26 to the other LR-client 26 shown in FIG. 4. The topology of this local area network arrangement is such that any one client 26 or 28 in this installation can connect to any other client. Similarly, the SR-clients 28 can connect to either of the two LR-clients 26. A network topology as shown in FIG. 4 has several advantages. First, since there is one unified network, clients seeking files locally on other clients have a simple if not always direct path over very high speed network communications such as wireless Ethernet. Thus, any client can search every other client in the local installation before attempting to download a file over the typically slower long-range wireless link 34. Second, because every client can access both of the LR-clients 26 in the local network, there is built in redundancy. Consequently, even if one of LR-units 26 fails, the remainder of the clients in the installation will still be able to connect to central server 20 via the other LR-client 26. Also, the ability to access both LR-clients 26 result in an increased bandwidth capacity for communication to and from communication network 14. Thus, content data can be downloaded faster and updates can take place sooner.

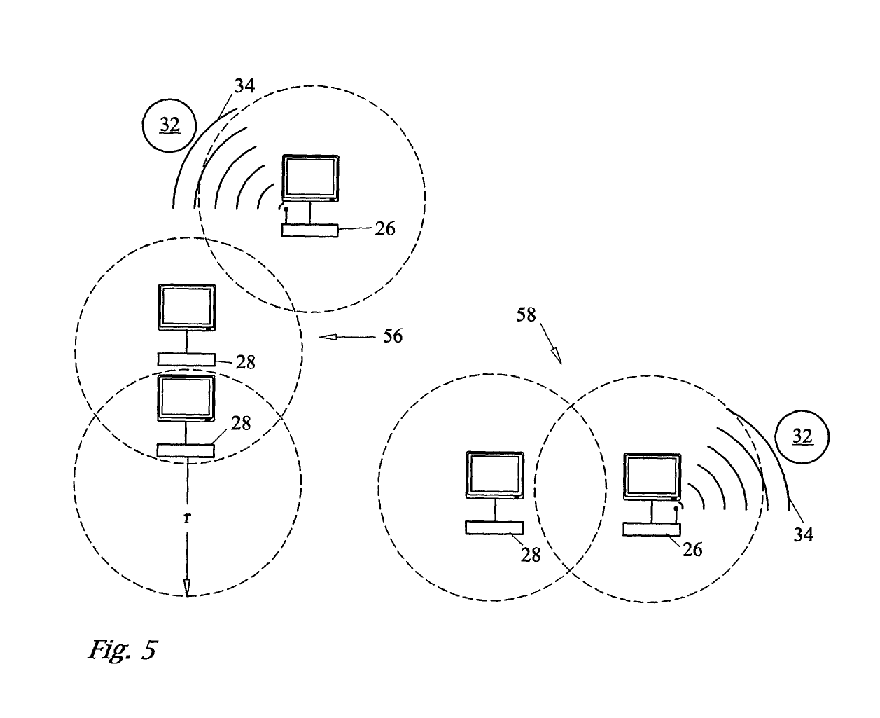

It is contemplated, however, that some installations do not lend themselves to a local network arrangement such as that shown in FIG. 4. The network arrangement shown in FIG. 5 describes one such example. Referring to FIG. 5, there are two distinct isolated local networks, each of which is capable of accessing communication network 14 via a wireless access point 32. Isolated local networks 56 and 58 can communicate with communication network 14, but are physically isolated from one another. This is the case because networks 56 and 58 may be several hundred meters apart and thus well beyond the range of the short-range wireless transceivers 48 proximity but places in isolated sub-networks (e.g. by their owners) for security or other reasons. Because each of networks 56 and 58 has only one LR-client 26 through which communication network 14 can be accessed, there is no redundancy. If the corresponding LR-client 26 fails, the local network cannot connect to central server 20. Of course, clients can continue to display the content they have already downloaded regardless of their ability to connect to central server 20.

Installations such as those shown in FIG. 5 may be desirable when it is essential to have clients disbursed across a wide area. All clients are individually addressable. Thus, provided that the clients have access to central server 20 via an LR-client 26, clients can still be configured to synchronize the content they will display, regardless of the physical location of client. This arrangement is possible because each client checks periodically throughout the day for new content and/or updates from central server 20.

As noted above, a user can, via user device 12, configure the system to logically group clients together to form a virtual network. It is also contemplated that end-users can create hierarchical groups-within-groups, i.e. nested groups, to increase their control over client configuration.

Regarding content to be played on the clients, although audio, video and/or multimedia (audio visual) content is described, it is further contemplated that the clients can be configured to 1) support interactivity with a customer such as through a kiosk, 2) provide web pages and/or 3) provide a custom user interface. Further, because video is downloaded to the client, full motion video such as Motion Picture Expert Group (MPEG) video or vector motion video can be provided in a manner which is reliable and of very high quality.

Reduced to its most general terms, the clients need to know 1) the topology of the network, 2) the most efficient path through the network, 3) which files to download, and 4) who has the files. As part of determining the topology of the network, each client must determine the available gateways, whether those gateways are separate devices or are implemented within LR-clients 26 or SR-clients 28.

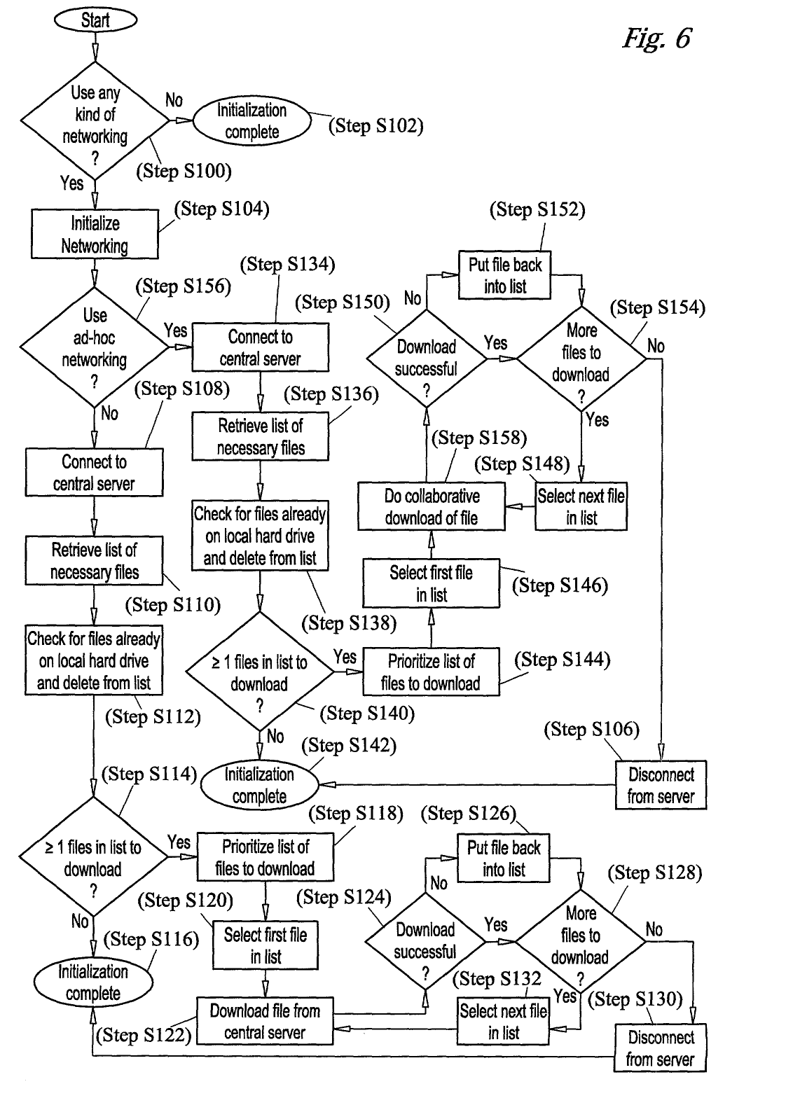

The detailed operation of the present invention is described with reference to FIGS. 6-11. Initially, it is noted that the operation of the present invention is described using script files and content files. It is understood that, as described above, instruction data can take forms other than script files and that content data can take forms other than as content files. Further, although the present invention describes nodes obtaining content files and script file by a downloading process, it is understood that nodes can obtain content data and instruction data by other methods, including by downloading multiple files and by a data streaming process.

FIG. 6 describes a primary initialization procedure performed by each client as it is turned on such as through a hard event, i.e. power-on event or a soft event, i.e. hardware/software reset event. Upon starting up, a determination is made as to whether any kind of networking should be used (step S100). The term “networking” as referred to with respect to step S100 refers to any external communication method such as via modem, local area network, etc. If no networking is to be used, the primary initialization is deemed complete (step S102) and no further initialization action is taken. If networking is to be used, the client initializes its networking (step S104) and determines whether ad-hoc networking is to be used (step S106). As used herein, ad-hoc networking refers to an arrangement whereby networking is established “on the fly” such that the assembly of the topology and performance characteristics of the network are determined as nodes (LR-clients 26, SR-clients 28, clients having gateway functionality and/or stand-alone gateway devices) are added and removed from the network. Ad-hoc networking is described in detail below.

In the case where ad-hoc networking is not used, it is presumed that the node has routing information which provides a path to central server 20. In this case, the node connects to central server 20 (step S108) to establish a communication session therewith. Methods for establishing session connections between two computing devices such as a client and a central server are known. For example, a typical communication device might use FTP to establish a file transfer session with an SQL server or establish a session for submitting general database queries to an SQL server. It is presumed that one of ordinary skill in the art would know how to establish such connections with a central server. The node retrieves a list of necessary files by retrieving the master script file (step S110). The node checks for files such as script files, content data, etc. which it may already have stored on its local hard drive and deletes those locally stored files from its file list (step S112). In the case where the node also stores information about other nodes on the network, if available, the list of files is analyzed to determine whether any files are to be downloaded (step S114). If no files are to be downloaded, the primary initialization of the node is complete (step S116) and the device is ready for normal operation. If one or more files are to be downloaded, the list of files is prioritized (step S 118), the first file in the list is selected (step S120) and the file is downloaded from central server 20 (step S122). As an example, the list of files can be prioritized according to one or more of the date of the request, the time of the request, the size of the file, the first scheduled date of play and/or the first scheduled time of play. Of course, the list can be prioritized using other criteria depending on the provider's preference.

File integrity is verified to determine whether the file was downloaded successfully (step S124). If the download was unsuccessful, the file name is put back into the list (or not deleted from the list) (step S126). If the download was successful or, in the case of an unsuccessful download put back into the list, the node determines whether there are more files to download (step S128). If there are no additional files to download, the node disconnects its session with central server 20 (step S130). If there are more files to download, the next file in the list is selected (step S 132) and the process returns to step S122 and the next file is downloaded from central server 20.

Referring again to step S106, in the case where ad-hoc networking is to be used, the sequence of steps shown in FIG. 6 as steps S 134-S156 are identical to those described with similarly shown steps S108-S120 and steps S124-S132. The only difference between the sequence of steps in the case where ad-hoc networking is used as opposed to where ad-hoc networking is not used as determined in step S 106 is that, in the case where ad-hoc networking is used, the file is collaboratively downloaded (step SI 58) as opposed to initiating a non-collaborative file download as set forth in step S122. Collaborative downloading is described in detail below.

It should be noted that, in the case of step S134 and step S108, the central server network address is preferably stored in a local configuration file on the node. This central server network address can be pre-configured as a default value prior to shipping the nodes. In the alternative, the central server address can be automatically provided to the node using any known automatic configuration technique. Upon completion of the process shown in FIG. 6, the node is initialized and ready to engage in normal operation.

Once the nodes have been initialized and files downloaded, where appropriate, each node periodically determines whether there are updated or new script files and downloads these files. As discussed above, the master script file can include information as to the times and dates for the update and subsequent script file and/or content data download. In other words, the update and file download procedure is triggered by another program according to the configuration settings stored in the node's configuration file.

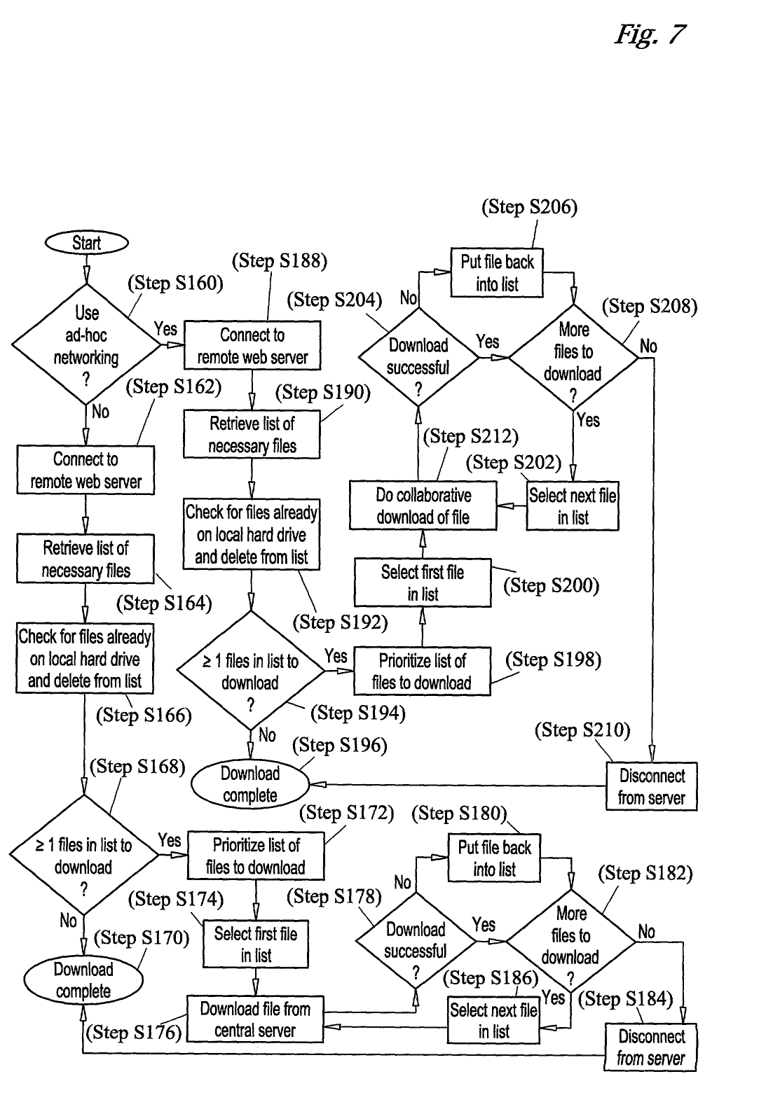

An example of the update and file download procedure for an initialized node is shown in FIG. 7. The process shown in FIG. 7 is virtually identical to that shown and explained with reference to FIG. 6, the differences being that the update and file download procedure shown in FIG. 7 does not include any steps which correspond to steps S100-S104 in FIG. 6 and the terminating steps in FIG. 6, namely step S1 6 and step S142, indicate an initialization complete status while the corresponding steps S170 and S196 in FIG. 7 indicate a download complete status. In other words, steps S106-S158 correspond to respective steps S160-S212 in FIG. 7. As such, for the sake of simplicity, an explanation of these steps is not included and the reader is referred to the discussion of the corresponding steps in FIG. 6 above.

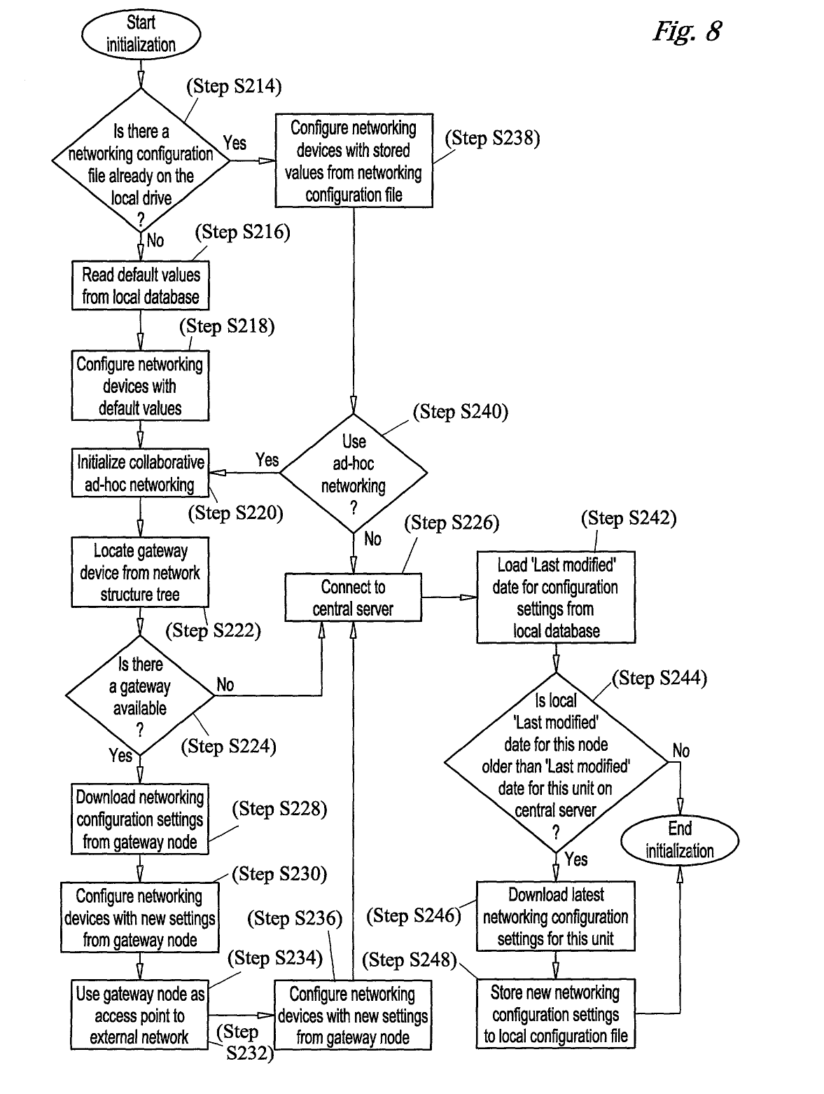

The initialize networking process of step S104 in FIG. 6 is described with reference to FIG. 8. Initially, a determination is made as to whether a networking configuration file is present on the client's local drive (step S214). A networking configuration file preferably includes one or more of the network address of central servers 20 along with corresponding access IDs and passwords, the network address of the node or an indication that the node is to use dynamic addressing, the network interface to use as the primary means of communication with other nodes, an indicator as to whether the node is to use any form of networking along with network IDs and passwords, an indicator as to whether the node is to use ad-hoc networking, an indicator as to whether the node is to use wireless networking, an indicator as to whether the node has a permanent link 22 or a non-permanent line 22 such as an ISDN or modem link and the network address of a local gateway node.

In the case where a networking configuration file does not exist on the client's local drive, default values sufficient to initialize networking, such as data and indicators corresponding to one or more of the data and indicators described above with respect to the networking configuration file which are pre-installed at the factory are read from the client's local database (step S216) and used to generate a networking configuration file. The client configures its networking with the default values (step S218) and initializes its collaborative ad-hoc networking processes (step S220). As part of step S220, described below in detail, a network structure tree is created in the memory of the client. The network structure tree is a non-balanced linked tree which provides a representation of the network the client (node) is in along with a list of the content data available on other nodes in the network. The root of the tree is the subject node. Each node may be connected to zero, one or more than one other node and each node may have zero, one or more than one content data. This network structure tree includes routes through the network to each node, along with an indication as to whether the node is a gateway node and a weight associated with the path to the node. For example, the weight can relate directly to distance to the node, time delay, etc.

If a gateway is not available for the client to use, the client will connect directly to central server 20 to attempt to load the networking configuration file (step S226). If a gateway is available (step S224) the networking configuration settings are downloaded from the gateway node (step S228), the node is configured with the new settings obtained from the gateway node in accordance with the networking configuration settings (step S230), and the node will use the gateway node as its access point to communication network 14 (step S232). The new network configuration settings are stored on the local drive (step S234) and the client connects to the central server in accordance with step S226.

Referring back to step S214, when a networking configuration file is already on the local drive, the client is configured using the stored values from the networking configuration file (step S238).

If ad-hoc networking is going to be used (ad-hoc networking is preferably enabled as a default) (step S240), the process continues with the initialize collaborative ad-hoc networking process (step S220), described below in detail. Where ad-hoc networking is not going to be used, the process continues by connecting to central server 20 (step S226).

After the client connects to the central server (step S226) the “last modified” date for configuration settings is loaded from the client's local database (step S242). It should be noted that a time stamp marking referring to the last time the configuration settings were modified is stored as part of the network configuration file. If the “last modified” date for the client is older than the “last modified” date for the client as loaded from central server 20 (step S244), the latest network configuration settings for the client are downloaded from central server 20 (step S246) and stored in the client's local configuration file (step S248) and the initialization process ends. If the “last modified” date for the client is not older than the “last modified” date for the client as loaded from central server 20, the initialization process is ended without downloading the configuration settings from central server 20.

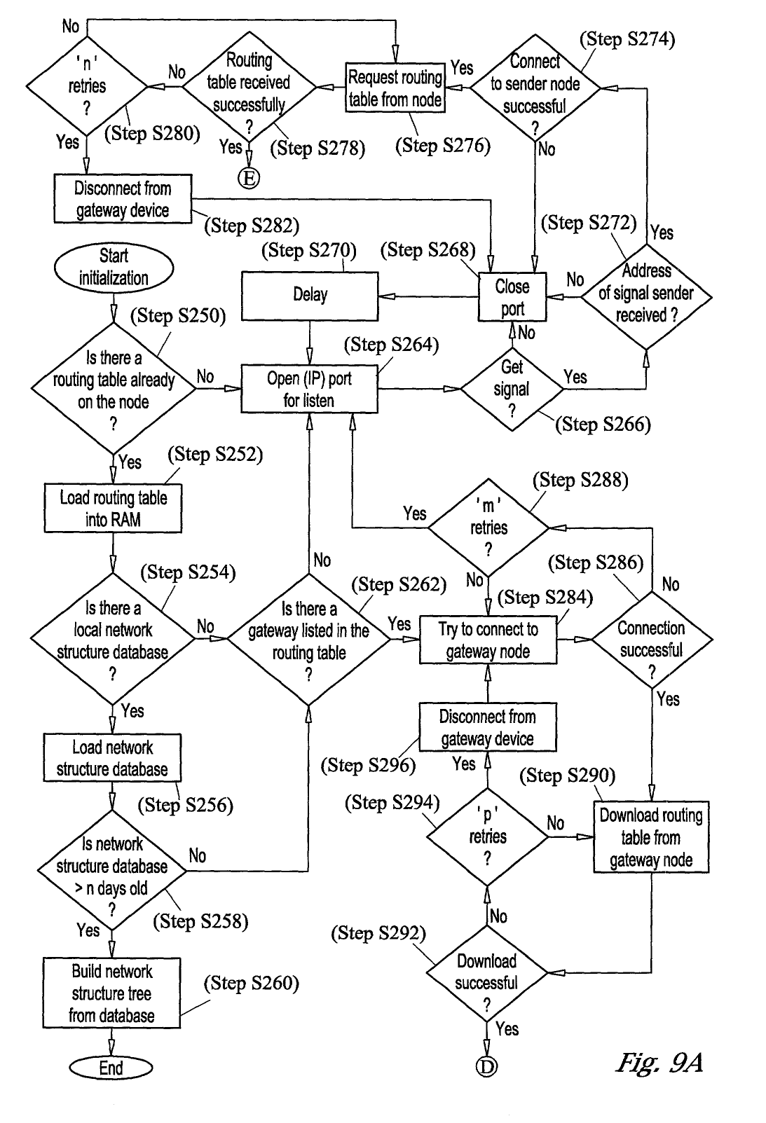

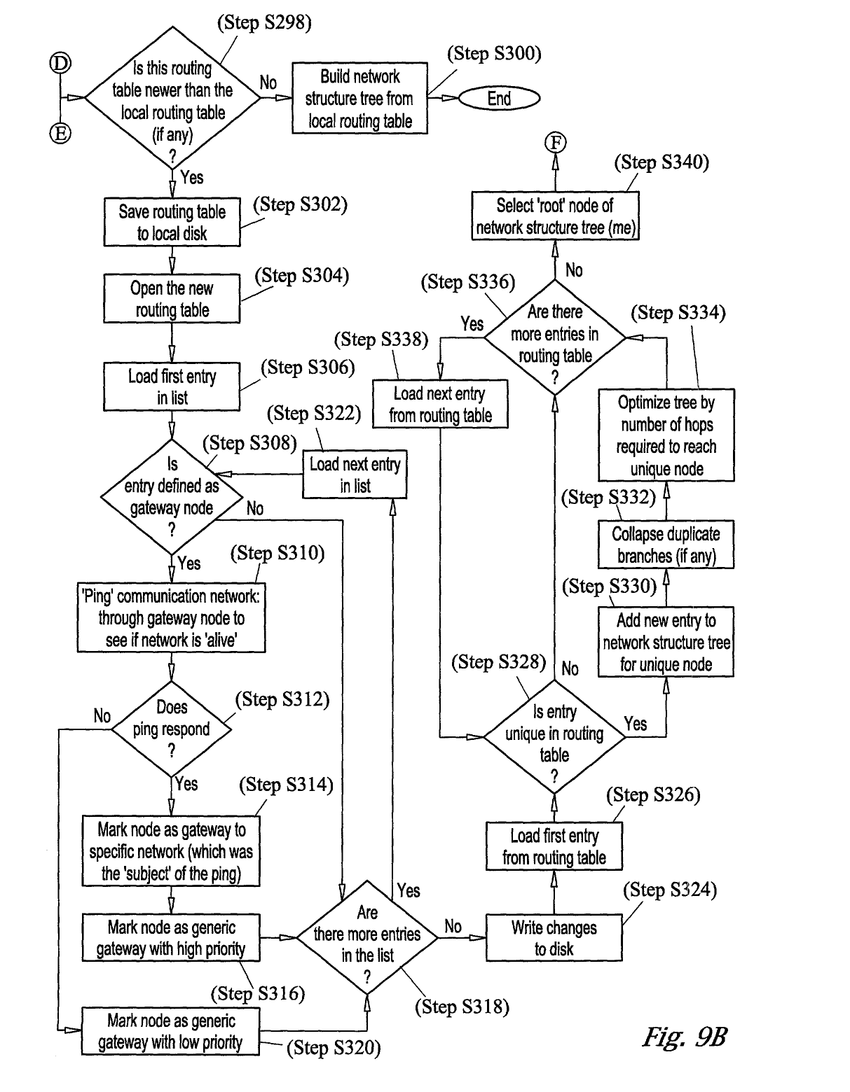

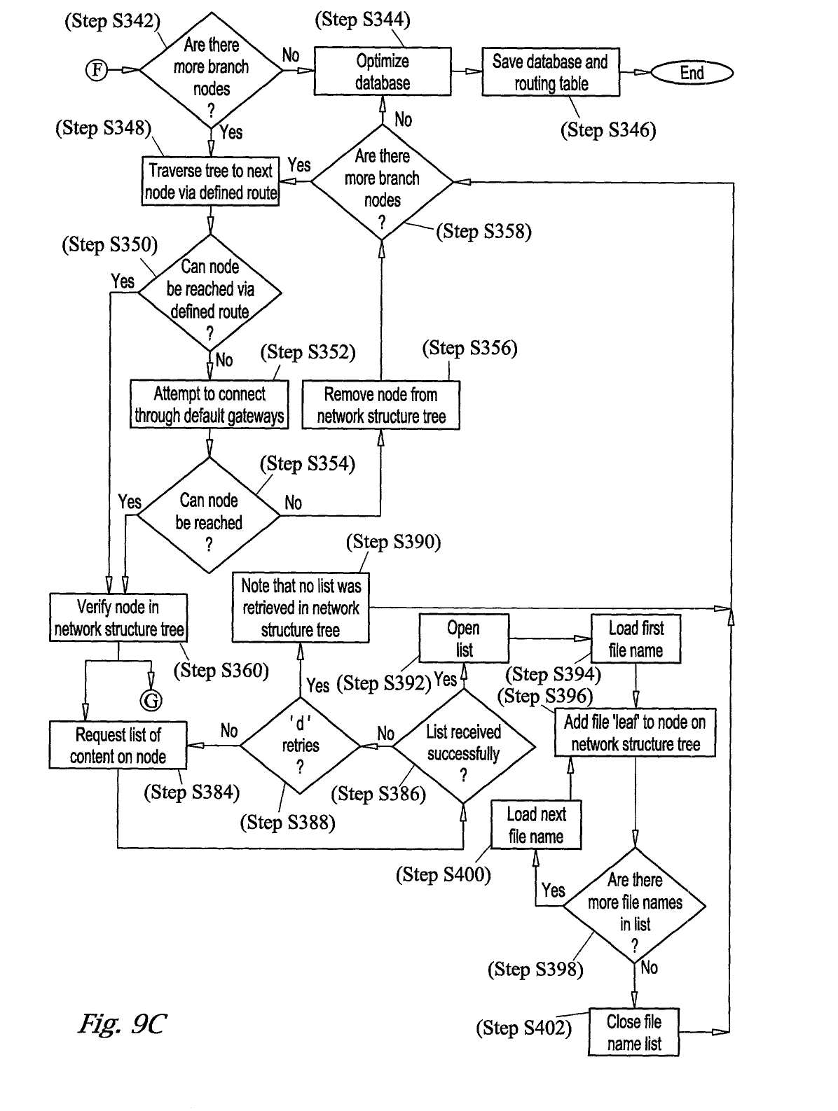

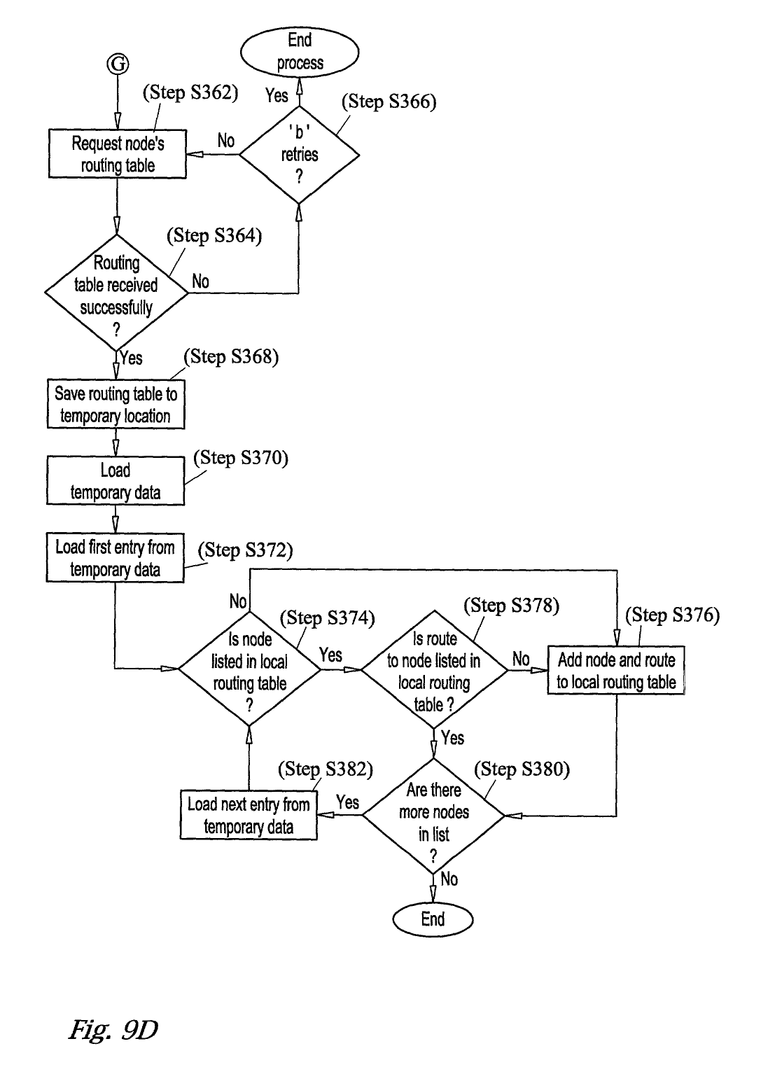

Step S220 in FIG. 8 refers to initializing the collaborative ad-hoc networking process. This process is described with reference to FIGS. 9A-9D.

A determination is made as to whether a routing table already exists on the node which is being initialized (step S250). A routing table is a file used by the node to store network information, including information about other nodes on the network. The routing table preferably takes a form similar to UNIX-based system routing tables. However, in addition to the traditional routing information included as part of a UNIX routing table such as route information for default routes and destinations, routing tables constructed in accordance with the principles of the present invention also include a complete list of every node which has ever been located on the network, as well as route and destination information as to how to reach these nodes. Further, a routing table constructed in accordance with the principles of the present invention includes information as to whether each device is a gateway or has other special properties which might affect how the network of nodes cooperate and function together.

If a routing table exists on the node, the routing table is loaded into RAM (step S250). If there is a network structure database stored in the node (step S254), the network structure database is loaded into RAM (step S256). If the network structure database is not older than a predetermined number of days, where that predetermined number is defined as “n” (step S258), the network structure tree is built from the network structure database (step S260) and the initialization for collaborative ad-hoc networking is deemed complete (step S260).

The network structure tree and the network structure database include substantially the same data. The network structure tree arranges the data in tree form when in use and is preferably maintained in a memory suitable for quick access such as RAM. The network structure database stores the data needed to assemble the network structure tree in a non-volatile memory such as a hard drive or flash memory. Having a network structure database allows the node to store the last used tree and to make periodic updates to quickly rebuild the network structure tree if required.

It should be noted that there is no significant difference between using the network structure database to build the network structure tree and using the node's routing table to build the network structure tree. The main difference is that the network structure database is what a node builds its own network structure tree from. The database is self-centric. Routing tables, on the other hand, serve at least two purposes. First, routing tables include information which is not included as part of the network structure tree, namely how to reach external, non-local networks. This type of information is included in traditional UNIX routing tables. Second, routing tables include routes to other networks in a non-centric format. As such, a node could construct its network structure tree using another node's routing table, while it would be very difficult to construct its network structure tree from another node's network structure database.

In the case where there is no local network structure database (step S254) or where the network structure database is older than the predetermined number of days in step S258, the routing table already on the node is evaluated to determine whether a gateway is listed in the routing table (step S262). If there is no gateway, a logical port such as an Internet Protocol port is “opened” for listening (step S264). Similarly, the process described with respect to step S264 is performed if there is no routing table already on the node as set forth in step S250. The port information regarding which port to open is preferably stored in both the default and updated network configuration files and is loaded into RAM as part of the network initialization process described with respect to FIG. 8.

If a signal is not received on the open port (step S266), the port is closed (step S268), a predetermined delay period is allowed to elapse (step S270) and the port reopened for listening (step S264). If a signal is received in step S266, the signal is evaluated to determine the address of the signal sender (step S272). If the address is not received as part of the signal such as may occur when a signal path is noisy or otherwise has errors present, the sequence set forth in steps S268, S270 are performed and the port is re-opened for listening as set forth in step S264. If the address of the signal sender is received in step S272, an attempt is made to connect to the sending node (step S274). If the connect attempt is unsuccessful, the sequence described above with respect to steps S268, S270 and S264, respectively, are performed.

If a session connection to the sending node is successful in step S274, the node requests a routing table from the sending node (step S276). If the routing table is not received successfully by the initializing node (step S278) the initializing node attempts “n” times to retry (step S280). If “n” tries have elapsed, the initializing node disconnects from the sending node (step S282), the port is closed in accordance with step S268 and the delay and reopen processes of steps S270 and S264 are performed. Referring again to step S262 in FIG. 9A, if a gateway is listed in the routing table the initializing node attempts to connect to the gateway node (step S284). If the connection is unsuccessful (step S286), the initializing node attempts “m” retries (step S288) to connect to the gateway node. If “m” retries have elapsed, the open IP port process of step S264 and its sequence thereof is performed. If the gateway node connection in accordance with step S268 is successful, the routing table is downloaded from the gateway node (step S290).

If the download is not successful, the initializing node attempts “p” retries by repeating step S290. After “p” retries, the initializing node disconnects the session from the gateway device (step S296), and tries again to connect to the gateway node in accordance with step S284. If the routing table download in step S292 is successful, the initializing node reviews the downloaded routing table to determine whether the routing table is newer than any existing local routing table (step S298). If the downloaded routing table is not newer, the network structure tree is built from the local routing table (step S300). If the downloaded routing table is newer than the initializing node's routing table in step S298, the routing table is saved to the local disks (step S302), the new routing table is opened (step S304) and the first entry in the routing table list is loaded into memory (step S306).

If the loaded entry is defined as a gateway node (step S308), a device in communication network 14 is “pinged” through the gateway node to see if the network is “alive” (step S310). If there is a response to the ping (step S312), the node is considered alive and is marked as a gateway to the specific network which was the subject of the ping (step S314). The node is also marked as a generic gateway having high priority (step S316) and a determination is made as to whether there are more entries in the routing table list (step S318). If there is no response to the ping in step S312, the node is marked as a generic gateway having low priority (step S320) and the process reverts to determining whether there are more entries in the list (step S318). If there are more entries in the list, the next entry is loaded (step S322) and the process of steps S308-S320 are repeated. If there are no additional entries in the routing table list in accordance with step S318, changes regarding how nodes are marked are stored (step S324).

At this point, the initializing node has an up-to-date routing table in which gateway nodes to specific networks have been marked, has determined generic gateways and has determined priorities with respect to the generic gateways.

A network structure tree is now built as follows. The first entry from the routing table is again loaded and a determination made as to whether this entry is unique (step S328). If the entry is unique, a new entry is made to the network structure tree corresponding to the unique node (step S330), any duplicate branches are collapsed (step S332) and the network structure tree optimized by a parameter such as the number of hops required to reach the unique node in a manner which eliminates duplicates, for example, through a sorting algorithm (step S334). Steps S328-S334 are repeated for all entries in the routing table (step S336) by loading each subsequent entry (step S338) until all entries have been processed. At this point, a network structure tree has been built in memory.

The remainder of the initialization process described with respect to FIGS. 9A-9D relates to completing the structure tree to determine which files are present on which nodes and also to gather up other node's routing tables to further expand the initializing node's routing table. The “root” node of the network structure tree is selected (step S340). In this case, the root node is the initializing client itself. If there are no branch nodes in the routing table, i.e. routes to other networks or portions of networks, the database (step S342), the database is optimized (step S344), the database and routing tables are saved (step S346). Optimization is preferably a two step process. First, duplicate entries are removed. Second, the data is sorted by hop quantity from the root node, the subject node in this case. Sorting can be done, for example using heap sort and/or quick sort processes. The initialization process is ended.

In the case where there are more branch nodes in step S342, the tree is traversed to the next node via the route defined in the routing table (step S348) and a determination made as to whether that node can be reached via the defined route (step S350). If the node cannot be reached via the defined route, the initializing node attempts to connect to the defined node through default gateways using high to low priority (step S352). If this node cannot be reached (step S354), the node is removed from the network structure tree (step S356). If there are more branch nodes (step S358), steps S348-S356 are repeated. If there are no additional branch nodes (step S358) the database is optimized and database and routing tables saved in accordance with steps S344 and S346. If the node can be reached in step S354 via the default gateways or the node can be reached via the defined route in accordance with step S350, the node is verified as valid in the network structure tree (step S360).

Once a node has been verified, two processes are performed substantially in parallel with respect to each verified node, namely the node's routing table is retrieved and evaluated and a list of the content on the node retrieved and evaluated. The node routing table retrieval and evaluation process is described first.

The verified node's routing table is requested by the initializing node (step S362). If the routing table is not successfully received (step S364) after “b” retries (step S366) the node retrieval and evaluation process is ended. If the routing table is successfully received in accordance with step S364, the routing table is temporarily saved (step S368) and loaded into RAM (step S370). The first entry from the temporary data is loaded into a working memory space (step S372) and evaluated to determine whether the load is listed in the initializing node's routing table (step S374).

If the node is not listed in the initializing node's routing table, the node is added to the local routing table along with its corresponding route (step S376). If the node is listed in the local routing table, the routing table is evaluated to determine whether there is a route to the listed node (step S378). If the route is not listed, the route is added to the local routing table in accordance with step S376. If the route to the node is listed in the local routing table and in the case where the node and route have been added to the local routing table in accordance with step S376, the list is evaluated to determine whether there are any additional nodes (step S380). If there are additional nodes, the next entry is loaded (step S382) and the process of evaluation in accordance with steps S374-S380 are repeated until there are no additional entries in the received routing table.

The second substantially parallel process relating to receiving and evaluating the list of a node's contents is described. A list of contents on the verified node is requested (step S384). If the content list is not received successfully (step S386) the request is repeated “d” times (step S388). If unsuccessful after “d” retries, the network structure tree is updated to note that no content list was retrieved (step S390) and the process reverts to step S358.

If the content list was successfully received in accordance with step S386, the list is opened (step S392), the first file name from the list is loaded into a working memory area (step S394) and a “leaf” is added to the node on the network tree corresponding to where the file name can be retrieved (step S396). The list is evaluated to determine whether there are more file names in the list (step S398) and the process continues until all file names have been loaded (step S400) and added in accordance with step S396.

When all file names have been added as leaves to their corresponding nodes on the network structure tree, the file name list is closed and the process returns to step S358 until all branch nodes have been evaluated. The database is then optimized in accordance with step S344 and saved along with the routing table in accordance with step S346. Collaborative ad-hoc networking for the initializing node is complete It is noted that this process is performed by each initializing node using ad-hoc networking in accordance with FIG. 8.

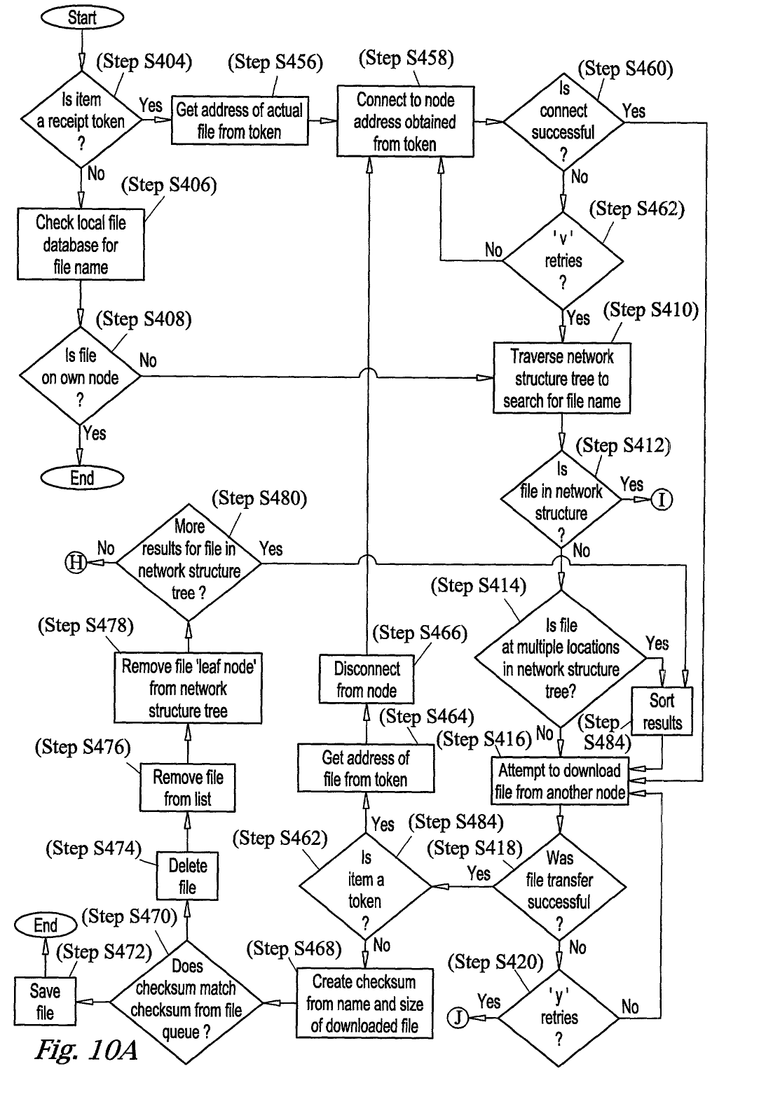

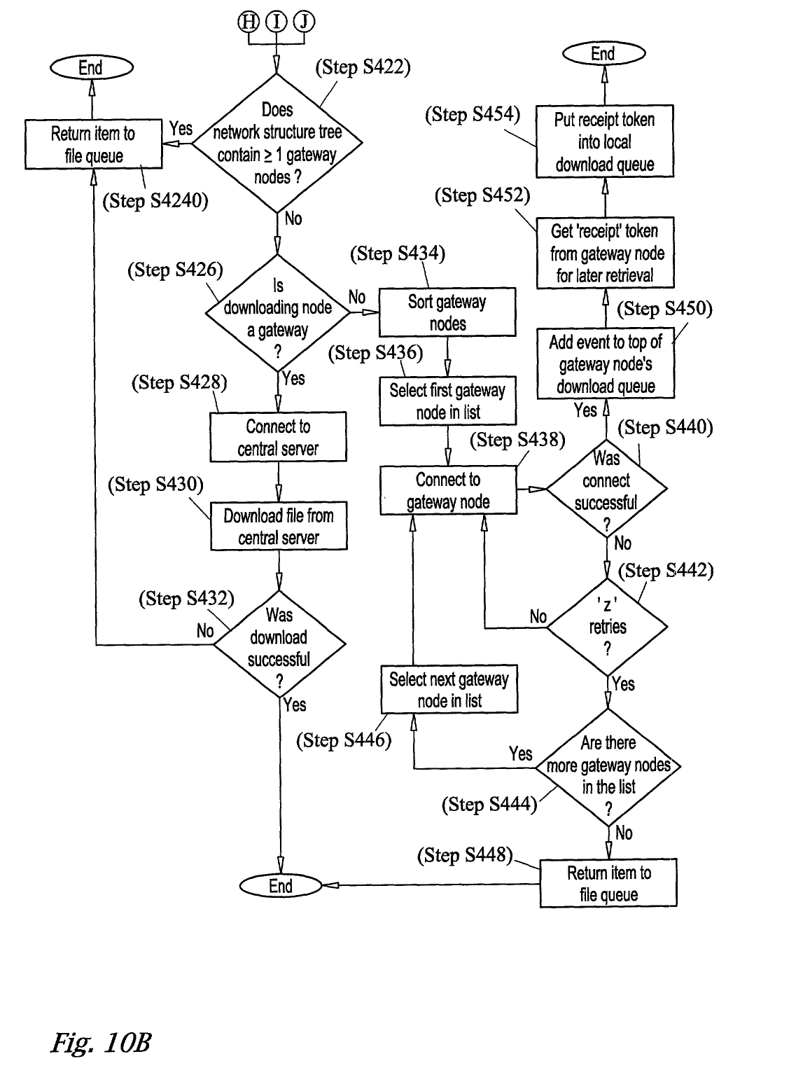

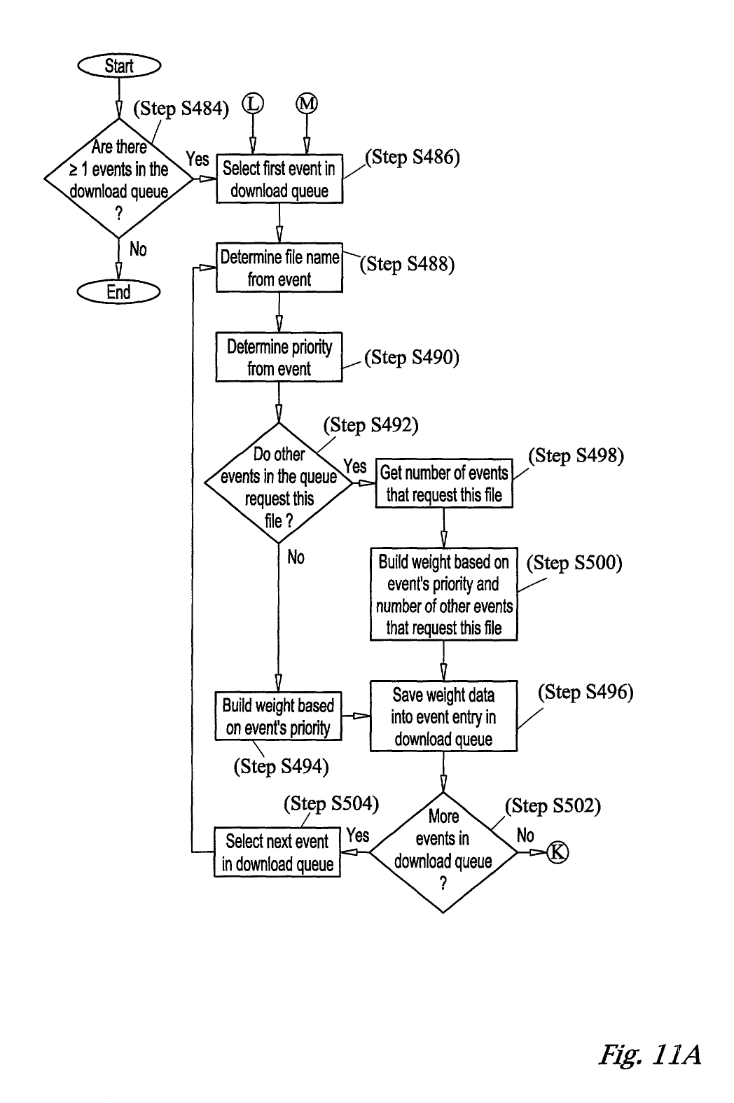

The processes described above with respect to FIGS. 8 and 9 describe processes in which a node determines a topology of the network, both local and via communication network 14, along with a route to these nodes, and any correspondence between these nodes and the content which may be found on the nodes. This scheme advantageously provides a method by which central server 20 is not overly taxed by repeated requests for content. In other words, each node has an indication of which nodes are gateways to the rest of the network, and who has what content. The actual collaborative download of files in the master and/or content script files noted as step S158 in FIG. 6 and step S212 in FIG. 7 as part of the primary initialization procedure and update and file download procedures, respectively, is described with reference to FIGS. 10A and 10B.

Initially, it is noted that the process described in FIGS. 10A and 10B relates to obtaining actual content data and does not relate to determination of network topology, routing tables, reachability, etc. The collaborative download process begins by loading a file name from the file queue. The file queue is defined as the list of files which must be obtained by the node based on the master or a content script file. The selected file is evaluated to determine whether it is an actual address or a “receipt token” (step S404).

Although the file download processes described with respect to FIGS. 6 and 7 refer to downloading actual content data, it is also possible that the received script includes a “receipt token”. A receipt token is a marker, much like a shortcut or symbolic link, which represents a file. A token includes a full network address, the name of the file being linked or downloaded, the name of the node that created the token so that two-way communication can be established between the creator of the token and the owner of the token and a time stamp. An item becomes a token as opposed to an actual file in the case where central server 20 knows that another node has already requested this file. In other words, a token is a pointer to the node that is going to have the file but does not yet have it.

If the item is not a receipt token, the node checks its own local content data database (step S406) to determine if it has the file (step S408). If the node has the file, the file download process is not required and therefore ends.

If the file is not on the local node, the node traverses its network structure tree to search for the file name to determine which node, if any, has the content data (step S410). If the file is found in the network structure tree (step S412), a determination is made as to whether the file can be found in multiple locations in the network structure tree (step S414). If the file is not at multiple locations but has been found in the network structure tree, the node attempts to download the file from the node which has the file according to the network structure tree (step S416). If the file transfer was not successful, the node attempts “y” times to download the file (step S420). After “y” retries, the node must look for the file elsewhere and attempt to obtain the file via a download from the gateway node also occurs if the file cannot be found in the network structure tree in step S412.

If the network structure tree does not contain at least one gateway node (step S422) the downloading node has no way to obtain the file and therefore returns the item to the file queue (step S424) and the process ends (step S424). If the network structure tree contains at least one gateway node in accordance with step S422, if the downloading node itself is a gateway (recall that the network structure tree includes an entry for the local node as the root node), the downloading node connects to the central server (step S428) using a known session connection process such as that described above and downloads the file from central server 20 (step S430) using a file download procedure such as FTP, UUCP and the like (step S430). If the download was not successful (step S432), the item is returned to the file queue (step S424) and the process ends. If the download was successful, the process ends.

Referring again to step S426, if the downloading node is not a gateway, the list of gateway nodes from the network structure tree is sorted (step S434) using, for example, the shortest to longest path as a sort criteria, and the first gateway node in the sorted list is selected (step S436). The downloading node attempts to connect to the selected gateway node (step S438). If the session connection attempt is not successful (step S440), the downloading node attempts to reconnect “z” times (step S442). If the connection cannot be established about “z” retries, the downloading node determines whether there are any additional gateway nodes in the list (step S444). If there are additional gateway nodes, the next node in the list is selected (step S446) and the file download process continues at step S438. If there are no additional gateway nodes in the list in accordance with step S444, the item is returned to the file queue (step S448) and the download process ends having unsuccessfully attempted to download the file.

Referring again to step S440, if the connection attempt to the gateway node is successful, an event is added to the top of the gateway node's download queue. The event includes the file name, priority, the I.D. of the downloading node and the date.

The gateway node sends the downloading node a receipt token indicating that the gateway node will download the file and that the file will be available for later retrieval (step S452). The downloading node puts the receipt token into its local download queue (step S454) and the download process ends temporarily with respect to that file. The gateway keeps a copy of the receipt token in its queue as well. Of note, step S404 evaluates whether an item in the local download queue is a receipt token.

The case where an item is a receipt token such as may be placed in a downloading node's download queue from a gateway node at step S404 is described. The local node evaluates the token to obtain the address of the node which has the actual file. For example, the actual file may be the gateway node which placed the token in the local node's file list (step S456). The downloading node attempts to establish a connection to the node address corresponding to the address obtained from the token (step S458). If the connection attempt is not successful (step S460) the downloading node attempts “v” times to retry (step S462). If the connection attempts are not successful after “v” retries, the process reverts to step S410 and the network structure tree is searched for the file name in an attempt to obtain the file from a node other than the node corresponding to the address in the token. If the connection attempt is successful in accordance with step S460, the downloading node attempts to download the file from the node in accordance with step S416.

Referring to step S418, when the file transfer is successful, the downloading node evaluates the file to determine whether that downloaded file itself is a receipt token (step S462). This situation may occur, for example, where the node from which the downloading node attempted to gain the file does not actually have the file and is waiting to download the file from another node. If the downloaded file is itself a token, the local node gets the address of the file from the token (step S464), disconnects from the node which provided the token (step S466) and the process reverts to step S458. If the item is not a token, it is assumed that the item is the actual file and a checksum based on the name and size of the downloaded file is created (step S468) in accordance with the checksum creation process described above. If the checksum matches the checksum obtained from the file queue (step S470), the file is validated and saved (step S472) and the download process for this file terminates. If the created checksum does not match the checksum from the file queue, the file is considered corrupt and is deleted from the download area (step S474). The file is also removed from the list corresponding to the download node (step S476) and the file leaf node is removed from the network structure tree (step S478). In other words, if a file is considered corrupt, the pointer to the file in the network structure tree is removed so that the downloading node will not attempt to download the corrupted file again.

If there are no additional entries for the file in the network structure tree (step S480), the download process reverts to step S422 in which the downloading node attempts to obtain the file via a gateway node. If there are additional entries for the file in the network structure tree, the entries are sorted, for example, by route length (step S482), and the process reverts to step S416 in which the file is attempted to be downloaded from another node.

It should be noted that, in accordance with step S414, if the file is located at multiple nodes in the network structure tree, the results are sorted in accordance with step S482. Therefore, in accordance with the present invention, the collaborative download process advantageously provides a method by which content data can be quickly located and downloaded from a sorted list of nodes, and, in the case where a node such as a gateway node does not yet have the file in its storage device, provides a mechanism by which the downloading node is provided with a token so that it can obtain the content data in the near future. This method minimizes the resource impact on central server 20, thereby allowing for very large distribution networks without the need for multiple, large scale, high performance central servers.

As discussed above, certain nodes including LR-clients 26, SR-client 28 and stand-alone computing devices can function as gateways. The gateway function allows clients to access server 20 by serving as a logical interface between the local network (such as network 18) and communication network 14. Although one may generally think of a gateway as a “router”, such is not the case in the present invention. Although it is contemplated that a gateway can provide traditional routing functionality, a gateway constructed in accordance with the principles of the present invention supports the collaborative downloading process, discussed below in detail. In general terms, the gateway collaborative downloading process is the process which gateway devices perform when trying to download lists of files from central server 20, from other nodes in the same local network or nodes on different networks. As part of the collaborative downloading process, a gateway downloads lists of files which, in many cases, have been requested by other nodes in the network. By caching the lists of files, network performance is increased because local nodes or nearby nodes need not always request lists of files from central server 20.

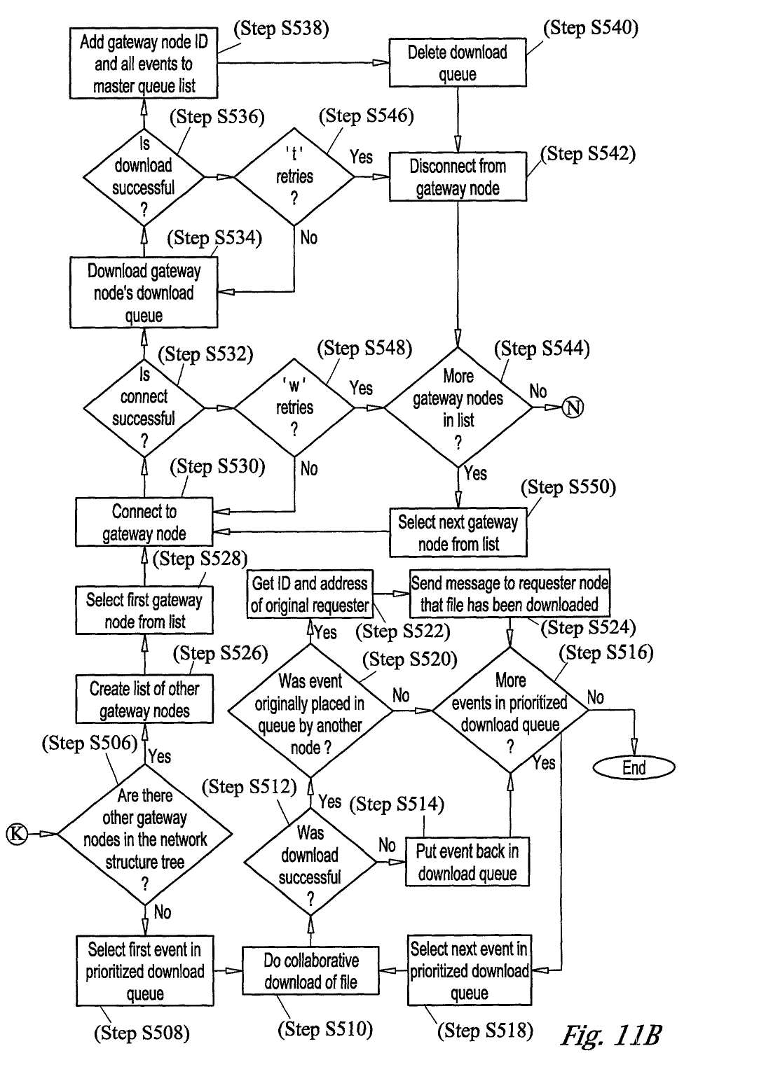

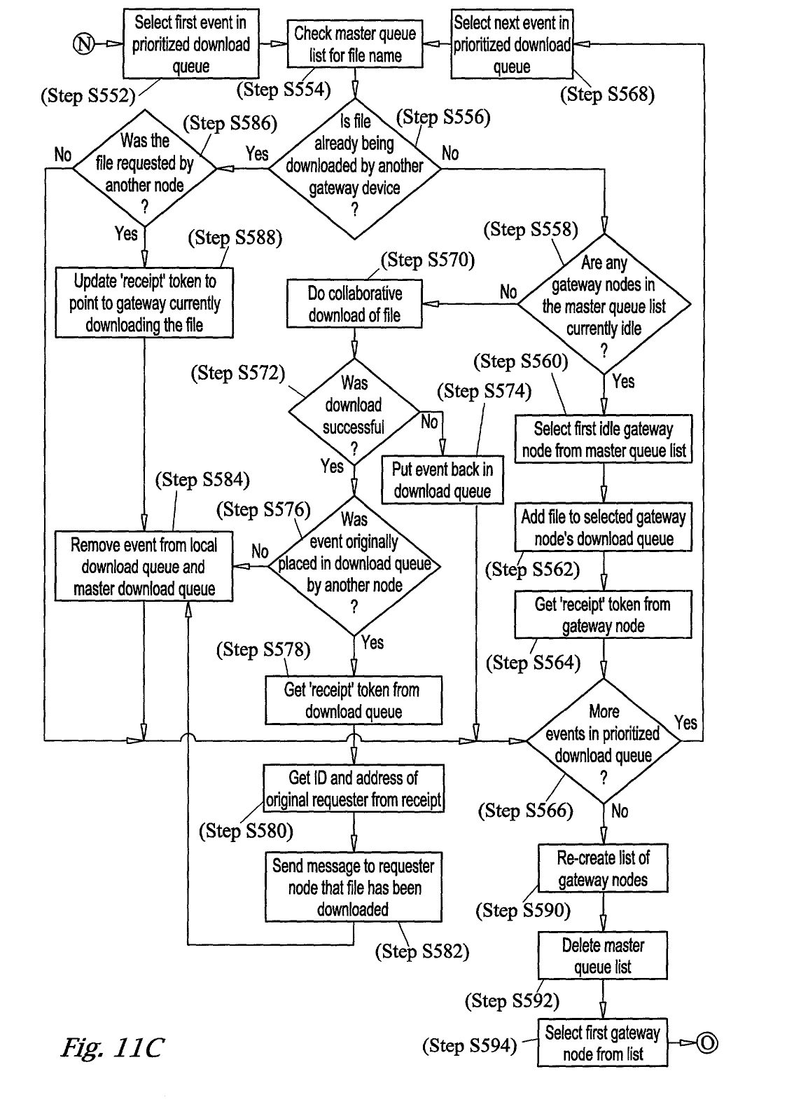

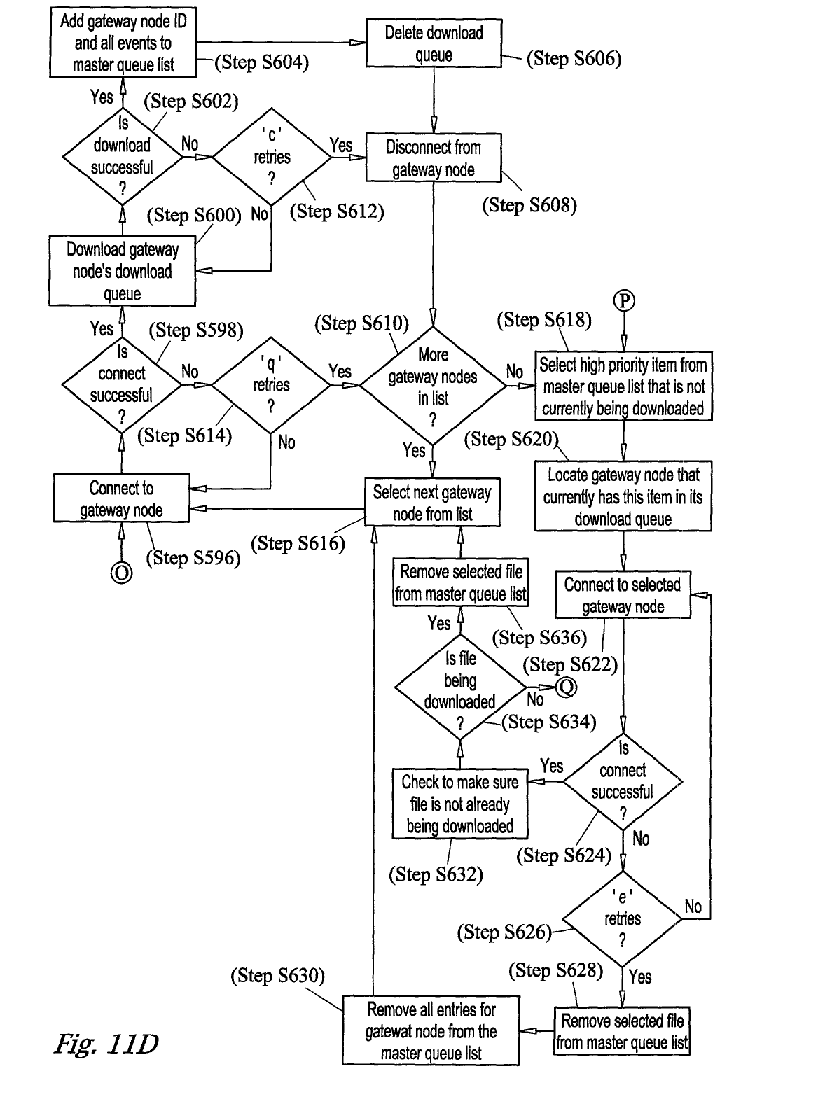

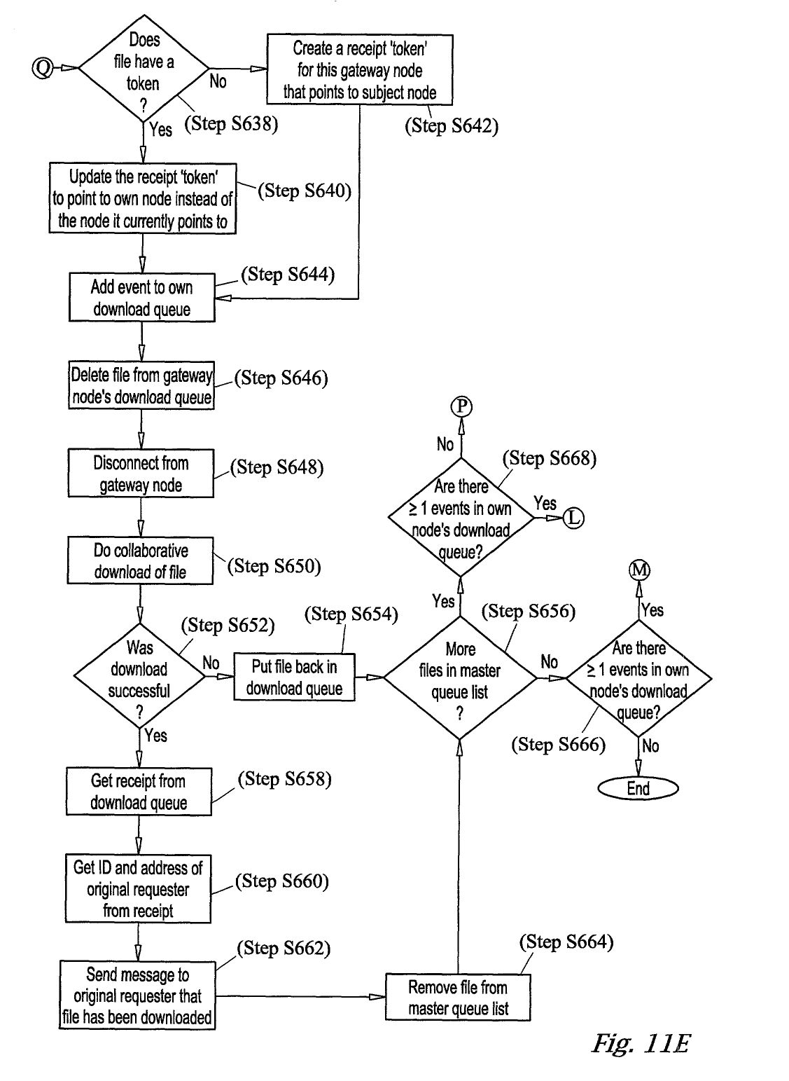

The gateway node process of the present invention is described with reference to FIGS. 11A-11E. This gateway process is performed by devices functioning as gateways and complements the collaborative download process described with respect to FIGS. 10A and 10B.

Periodically, a gateway node evaluates its download queue to determine whether there are any events which must be serviced (step S484). The triggering mechanism can be some system event, a periodic evaluation of the event queue to determine whether there are any entries in it, etc. If there are no events in the download queue, the process ends until restarted at some point in the future. If there are events in the download queue, the gateway node selects the first event in the download queue (step S486), the file name corresponding to the event is determined (step S488) and the priority of the event is determined (step S490). Recall that each event includes the file name along with its relative priority.

If no other events in the queue request this same file (step S492), a weight metric is determined corresponding to the event's priority (step S494) and the weight metric is saved along with the corresponding event entry in the download queue (step S496). As such, in the case where no other events in the queue request the file, the weight metric attributed to the event based on the event's priority and preferably does not include any other factors (although consideration of other factors is possible).

If there are other events in the queue which request the file (step S492), the gateway node determines the quantity of events requesting the same file (step S498) and a weight metric for the file is determined based on the event's priority along with quantity of other events which request this same file (step S500). The weight metric is saved into the corresponding event entries in the download queue (step S496). The weighting process in accordance with steps S488-S500 continues for all events in the download queue (step S502 and S504) creating a prioritized download queue.

If there are no other gateway nodes in the network structure tree, i.e. the gateway node for which the process is being described as the only gateway node in the network (step S506), the first event in the prioritized, i.e. weighted download queue is selected (step S508) and the file is collaboratively downloaded using the file name corresponding to the event (step S510). The process corresponding to step S510 is described in detail in FIGS. 10A and 10B. If the collaborative download was not successful (step S512), the event is placed back in the download queue (or not deleted from the download queue) (step S514). The download queue is evaluated to determine whether there are more events which need to be serviced (step S516). If there are no additional events, the gateway process is ended. If there are more events in the prioritized download queue (step S516) the next event is selected (step S5 18) and the process reverts to the collaborative download step (step S510).

Referring again to step S512, if the download was successful, the gateway node determines whether the event was originally placed in the queue by another node by evaluating the address corresponding to the event (step S520). If the event was not placed in the event queue by another node, the process reverts to step S516. If the event was originally placed in the queue by another node, the UIN and address of the original requesting node is obtained, for example, from a copy of a receipt token which was provided to the requesting node and also stored by the gateway (step S522). A message is sent to the requesting node that the file has been downloaded and is ready for collaborative download to the requesting node (step S524).

Referring again to step S506, when there are other gateway nodes in the network structure tree in addition to the gateway node corresponding to the described process shown in FIGS. 11A-11E, the subject gateway node creates a list of other gateway nodes (steps S526), selects the first gateway node from the list (step S528) and attempts to establish a connection session with that selected gateway node (step S530). If the connection attempt is successful (step S532), the download queue for the selected gateway node is obtained by the subject gateway node (step S534). If the download is successful (step S536), the gateway node UIN corresponding to the downloaded queue is added to all events in the subject gateway node's master event queue list and (step S538) and the downloaded queue is deleted (step S540).

The master queue differs from the event queue because the master queue contains event data from every download queue of every gateway device. This master queue list therefore tells the corresponding gateway node which other gateways are currently downloading content, what other content is queued up to be downloaded later and what kind of load each gateway is under.

The subject gateway node disconnects its session with the node whose event queue was downloaded (step S543) and the subject node determines whether there are any additional gateway nodes in the gateway node list (step S544). Referring to step S536, if the event queue download is not successful, the subject node attempts “t” times to download the queue. If the download is unsuccessful after “t” retries, the process reverts to step S542 and the session between the two gateway nodes is disconnected. Similarly, if the subject gateway node cannot even connect to the other gateway node in accordance with step S532, the subject node will attempt “w” times to establish the connection (step S548) prior to reverting to step S544 to determine whether there are other gateway nodes in the list. If there are additional gateway nodes in the list, the next gateway node from the list is selected (step S550) and the process reverts to step S530.

At the point in which step S544 has been completed and there are no additional gateway nodes in the list which need to be evaluated, a list of every file in the queue on every gateway device has been created as part of the master queue and, by proxy the activity of every gateway device is determined, i.e. how busy the other gateway devices are based on the size of their respective download queues.

The subject node evaluates its prioritized download queue and selects the first event (step S522). The subject gateway node also checks its master queue list to determine whether the file name is in that master queue (step S544). If the subject gateway node determines that the file is not already being downloaded by another gateway device (step S556) based on the event information, the subject gateway node determines whether there are any gateway nodes in the master queue list which are currently idle (step S558). This determination can be made, for example, by noting that there are no download events corresponding to a particular gateway node in the master queue list.

If there are idle gateway nodes, the first idle gateway node from the master queue list is selected (step S560) and an item corresponding to the selected event, i.e. the content data name, is added to the selected gateway node's download queue (step S562). The selected gateway node provides the subject gateway node with a receipt token (step S564). If there are additional events in the prioritized download queue (step S566) the next event is selected (step S568) and the process reverts to step S554.

Referring again to step S558, if there are no idle gateway nodes, the subject node initiates a collaborative download process to obtain the file as described in FIGS. 10A and 10B (step S570). If the download was not successful (step S572) the event is put back in the download queue (step S574) and the process reverts to step S566. If the download of the file was successful (step S572) and the event was originally placed in the subject node's download queue by another node (step S576), the corresponding receipt token from the subject node's download queue is evaluated (step S578) to obtain the UIN and address of the original requestor (step S580). A message is sent to the requesting node that the gateway node now has the requested file (step S582). The file is then removed from the local download queue and the gateway node's master download queue (step S584) and the process reverts to step S566. Referring to step S576, if the event was not placed in the subject node's download queue by another node, the process reverts to step S584 and the event is removed from the local download queue and the master download queue.

Referring again to step S566, if the file is already being downloaded by another gateway device, the subject gateway node determines whether the file was requested by a different node (step S586). If the file was not requested by another node, the process reverts to step S566, described above. If the file was requested by another node, the receipt token in the subject node's event queue is updated to point to the gateway node which is currently downloading the file (step S588) so that the subject gateway now has a quicker means by which to obtain the file. The process then reverts to step S584 by which the event is removed from the subject gateway node's local download queue and the master download queue.

Referring again to step S566, when there are no additional events in the prioritized download queue to service, the subject node recreates the list of gateway nodes or retrieves the list from its memory (step S590), deletes the master queue list in its memory (step S592) and selects the first gateway node from the gateway node list (step S594).

The subject node attempts to connect to the selected gateway node (step S596). If the session connection attempt is successful (step S598), the other gateway node's download queue is obtained by the subject node (step S600). If the download is successful (step S602), the gateway node UIN and all events from the other node are added to the subject gateway node's master queue list (step S604) and the downloaded download queue is deleted from the subject gateway node (step S606).

The session between the two gateway nodes is disconnected (step S608) and the subject node determines whether there are any additional gateway nodes in the gateway node list (step S610). Referring to step S602, if the download attempt to obtain the download queue from the other node is not successful, the subject gateway node attempts “c” retries (step S612). If, after “c” retries, the download is still not successful, the process reverts to step S608.

Referring back to step S598 relating to the connection attempt between the subject gateway node and another gateway node, if a connection cannot be established after “q” retries (step S614), the process reverts to step S610. If there are additional gateway nodes in the list which have not yet been evaluated, the next node in the gateway node list is selected (step S616) and the process reverts to step S596.

In sum, steps S590-S616 recreate the master queue list, thereby providing an up-to-date master queue. Of course, it is contemplated that the original master queue list can be used for the following steps. The following discussion relating to FIGS. 11A-11E describes the process by which the master queue list is used to obtain high priority files from other nodes in order to quickly service other gateway nodes which have high priority requests outstanding. In other words, once the subject gateway node has serviced all of its events, it now attempts to service high priority events still outstanding on other gateway nodes.

Initially, the highest priority file is selected from the master list which is not currently being downloaded by another gateway node (step S618). The subject gateway node locates the gateway node which currently has this item in its download queue (step S620) by evaluating its network structure tree (step S620). The subject node connects to the selected gateway node (step S622).

If the connection is not successful (step S624), the subject node attempts “e” times to connect (step S626). If the subject gateway node cannot connect after “e” retries, the selected file is removed from the master queue list (step S628) and all entries for the gateway node for which connection was unsuccessful are removed from the master queue list (step S630). The process then reverts to step S618 and the next high priority item is selected. Referring again to step S624, if the session connection is successful, the subject gateway node checks to make sure that the file is not already being downloaded by the node which has the item in its download queue (step S632). If the file is being downloaded, the subject gateway node does not need to service the request and (step S634) removes the selected file from its master queue list (step S636). The process then reverts to step S618.

If the file is not the actual file but is instead a corresponding receipt token (step S638), the receipt token is updated to point to the subject node in stead of the note it currently points to (step S640). If the file does not have a token, a receipt token is created for the other gateway node which points to the subject gateway node (step S642). In either the case of step S640 or step S642, an event corresponding to this file is added to the subject node's download queue (step S644). The corresponding event is deleted from the other gateway node's download queue (step S646) and the session between the two gateway nodes is disconnected (step S648). The subject gateway node then performs a collaborative download of the file (step S650) in accordance with the process described in FIGS. 10A and 10B.

If the collaborative download was unsuccessful (step S652) the event is placed back in the download queue (step S654) and the master queue list evaluated to determine whether there are additional files to be downloaded (step S656). If the download was successful, the subject gateway node evaluates its download queue to get the token receipt (step S658) to obtain the UIN and address of the original file requestor (step S660). The subject gateway node sends a message to the original requesting node that the file has been downloaded by the subject gateway node and is available for download to the original requestor (step S662). The file is removed from the master queue list on the subject gateway node (step S664) and the process reverts to step S656, If there are no additional files in the master queue list in accordance with step S656, the subject node determines whether there are any events in its own download queue (step S666). If there are no additional events, the gateway process ends. If there are additional events in the subject node's download queue, the process reverts to step S486.

Referring again to step S656, if there are additional files in the master queue list, the subject node determines whether there are any events in its own download queue (step S668). If there are events in its own download queue, the process reverts to step S486. If there are no events in its own download queue but there are still events in the master queue list, the process reverts to step S618 so that the subject gateway node can attempt to off-load the demand placed on other gateway nodes.

Once the content data are stored on the subject node, they are played at the designated times or in accordance with other playback instructions.

The present invention advantageously provides a comprehensive arrangement of hardware which maximizes the communication efficiency between nodes within close proximity to one another while still allowing for efficient use of long range bandwidth and minimal central server 20 demand, and also provides a highly efficient set of processes by which nodes learn the topology of the network, learn which content data are on which nodes, and provides a collaborative method for obtaining these files. This collaborative file distribution method advantageously allows gateway nodes to service their own local nodes as well as off-load high demand placed on other gateway nodes, thereby distributing the load among gateway nodes in the network. Further, the above-described arrangement and processes allows a set of virtual networks to be created within one larger physical network, thereby allowing a service provider to make use of economies of scale when implementing the present invention.

It is noted that variables “b”, “c”, “d”, “e”, “f”, “m”, “n”, “p”, “q”, “t”, “v”, “w”, “x”, “y” and “z” referred to above in the context of retries represent predefined integers greater than one. The variables can be hard-coded or made user selectable.

It will be appreciated by persons skilled in the art that the present invention is not limited to what has been particularly shown and described herein above. In addition, unless mention was made to the contrary, it should be noted that all of the accompanying drawings are not to scale. A variety of modifications and variations are possible in light of the above teachings without departing from the scope and spirit of the invention, which is limited only by the following claims.

What is claimed is:

1. A communication network-based content distribution system, comprising:
a central server, the central server storing instruction data, the instruction data including a name corresponding to content data;
a first node, the first node being in data communication with the central server via the communication network, the first node including:
a transceiver, the transceiver receiving the instruction data from the central server; and
a central processing unit, the central processing unit constructing a network structure table corresponding to a network topology and locations of content within the network; and
the first node using the network structure table to determine the location of content corresponding to the name of the content data in the received instruction data.

2. The system according to claim 1, further including a wireless access point, the wireless access point being coupled to the communication network, wherein the first node is a long range client having a wireless transceiver, the wireless transceiver providing wireless data communication between the wireless access point and the first node.

3. The system according to claim 2, wherein a distance between the wireless access point and the first node is at least approximately one hundred meters.

4. The system according to claim 2, further comprising a second node, the second node communicating with the central server via the first node.

5. The system according to claim 4, wherein the second node is a short range wireless client and wherein the second node has a wireless transceiver to perform wireless data communication with the first node.

6. The system according to claim 5, wherein a distance between the first node and the second node is not greater than approximately one hundred meters.

7. The system according to claim 4, wherein at least one of the first node and the second node is a gateway node, the gateway node having an event queue including a list of items requested by other nodes.

8. The system according to claim 7, wherein the list of items is arranged in a weighted order, the weighted order being based on priorities of requested items and a quantity of other nodes requesting each item.

9. The system according to claim 7, wherein the gateway node further has a master queue list, the master queue list being a compilation of event queues from other gateway nodes.

10. The system according to claim 9, wherein the gateway node functions to:
evaluate the master event queue to determine if any other gateway nodes are idle; and
adds a request to an idle other gateway node to obtain content data corresponding to an item in from the gateway node's event queue.

11. The system according to claim 10, wherein the gateway node further functions to store a receipt token received from the other gateway node, the receipt token corresponding to the requested content data and including the name corresponding to the content data and an address of the other gateway node.

12. The system according to claim 9, wherein the gateway node functions to:
evaluate the master event queue to select an item which is not currently being downloaded by a corresponding gateway node;
evaluate the master event queue to locate a gateway node which has the selected item;
send a receipt token to the other node which made the request, the receipt token corresponding to the requested content data and including the name corresponding to the content data and an address of the gateway node;
send a message to the corresponding gateway node to delete the selected event from an event queue on the corresponding gateway node.

13. The system according to claim 12, wherein the gateway node further functions to:
obtain content data corresponding to the selected event; and
notify the requesting node that the gateway node has obtained content data corresponding to the selected event.

14. The system according to claim 7, wherein the gateway node functions to provide content data to a requesting node, the provided content data corresponding to an event in the gateway node event queue.

15. A network-based content distribution method, comprising:
receiving instruction data from a central server;
constructing a network structure table corresponding to a network topology and locations of content within the network; and
using the network structure table to determine the location of content corresponding to a content data name in the received instruction data.

16. The method according to claim 15, wherein constructing a network structure table includes:
creating a routing table, the routing table including network routes to nodes in the communication network;
selecting a node from the routing table;
using the routing table to determine a route to the selected node;
establishing a communication session with the selected node using the determined route;
obtaining a list of available content on the selected node from the selected node; and
updating the network structure tree to include the selected node and the list of content available on the selected node.

17. The method according to claim 16, wherein the routing table and the network structure tree include an indicator identifying gateway nodes.

18. The method according to claim 17, wherein an identified gateway node is used to establish the communication session if a direct communication session can not be established with the selected node.

19. The method according to claim 16, wherein the list of content includes a receipt token, the receipt token providing an indication that the selected node does not yet have content corresponding to an item on the list of content.

20. The method according to claim 19, wherein the receipt token includes an address corresponding to another node having the content corresponding to an item on the list of content, the method further including obtaining the content corresponding to the item on the list of content from the other node.

21. The method according to claim 19, the method further including periodically checking with the selected node to determine whether the selected node has obtained the content corresponding to the item and obtaining the content corresponding to the item from the selected node if it is determined that the selected node has the content corresponding to the item.

22. The method according to claim 16, further comprising deriving a network structure database from the network structure tree and storing the network structure database in a non-volatile memory.

23. The method according to claim 15, further comprising assembling an event queue, the event queue including a list of items requested by other nodes.

24. The method according to claim 23, further comprising arranging the list of items in a weighted order, the weighted order being based on priorities of requested items and a quantity of other nodes requesting each item.

25. The method according to claim 23, further comprising assembling a master queue list, the master queue list being a compilation of event queues from other nodes.

26. The method according to claim 25, further comprising:
evaluating the master event queue to determine if any other gateway nodes are idle; and
adding a request to an idle other node to obtain content data from the other node's event queue.

27. The method according to claim 26, further comprising storing a receipt token received from the other node, the receipt token corresponding to the requested content data and including the name corresponding to the content data and an address of the other node.

28. The method according to claim 25, further comprising:
evaluating the master event queue to select an item which is not currently being downloaded by a corresponding node;
evaluating the master event queue to locate a node which has the selected item;
sending a receipt token to the other node which made the request, the receipt token corresponding to the requested content data and including the name corresponding to the content data and an address of the node;
sending a message to the corresponding node to delete the selected event from an event queue on the corresponding node.

29. The method according to claim 28, further comprising:
obtaining content data corresponding to the selected event; and
notifying the requesting node that the node has obtained content data corresponding to the selected event.

30. The method according to claim 23, further comprising providing content data to a requesting node, the provided content data corresponding to an event in the event queue.

31. The method according to claim 15, wherein the instruction data farther includes at least one play instruction corresponding to the content data name, the method further comprising playing the content data in accordance with the at least one play instruction.

32. A node in a network-based content distribution system, the node comprising:
a transceiver operable to receive instruction data, the instruction data including a name corresponding to content data;
a central processing unit in electrical communication with the transceiver, the central processing unit performing functions including:
constructing a network structure table corresponding to a network topology and locations of content within the network;
determining the location of content corresponding to the content data name in the received instruction data; and
using the transceiver to obtain the content corresponding to the content data name in the received instruction data; and
a playing device in electrical communication with the central processing unit, the playing device being operable to play the obtained content data.
